(19) United States
(12) Patent Application Publication
(10) Pub. No.: US 2025/0282156 A1
(43) Pub. Date: Sep. 11, 2025

(54) SHEET CONVEYANCE APPARATUS AND IMAGE FORMING SYSTEM

(71) Applicant: CANON KABUSHIKI KAISHA, Tokyo (JP)

(72) Inventor: AKINOBU NISHIKATA, Chiba (JP)

(21) Appl. No.: 19/068,283

(22) Filed: Mar. 3, 2025

(30) Foreign Application Priority Data
Mar. 8, 2024 (JP) 2024-035939

(51) Int. Cl. B41J 11/00; B65H 7/12

(52) U.S. Cl. CPC B41J 11/006; B41J 11/0095; B65H 7/12

(57) ABSTRACT

A sheet conveyance apparatus includes a conveyance portion, a switching portion, a multi-feeding detection portion, and a control portion. The multi-feeding detection portion disposed upstream of the switching portion in a sheet conveyance direction and detecting multi-feeding in which a first sheet and a second sheet that follows the first sheet overlap with each other. The control portion controls the switching portion for guiding the first sheet and the second sheet to the third conveyance path by switching the switching portion to the second position when multi-feeding is detected by the multi-feeding detection portion. When multi-feeding is detected by the multi-feeding detection portion, the control portion calculates a first time at which a trailing edge of the second sheet in the sheet conveyance direction has been passed through the switching portion, and switches the switching portion from the second position to the first position at the first time.

### BACKGROUND OF THE INVENTION

### Field of the Invention

The present invention relates to a sheet conveyance apparatus that conveys sheets, and an image forming system.

### Description of the Related Art

For feeding sheets from a component such as a cassette or a tray, a separation pad or a separation roller is disposed for separating a sheet from others, one by one. However, if a following sheet sticks to a preceding sheet, multi-feeding may occur. In the multi-feeding, the preceding sheet is conveyed in a state where the following sheet overlaps with the preceding sheet. The multi-feeding may cause a defect in image formation, a jam, a failure, and the like. For this reason, Japanese Patent Application Publication No. H11-24506 proposes a configuration in which the conveyance is stopped if the multi-feeding of sheets (paper sheets) is detected.

However, the configuration proposed in Japanese Patent Application Publication No. H11-24506 and configured to stop the conveyance may reduce the productivity because the downtime occurs. Japanese Patent Application Publication No. 2002-333797 proposes a configuration in which if the multi-feeding is detected, the multi-fed sheets are discharged without performing the formation of images, and the images are formed on the following sheets. Japanese Patent Application Publication No. 2002-333797 also proposes a technique in which the multi-fed sheets are discharged to a predetermined discharging tray other than a specified sheet-discharging tray.

By the way, for switching the tray from the specified sheet-discharging tray to the other discharging tray and discharging the multi-fed sheets to the other discharging tray as proposed in Japanese Patent Application Publication No. 2002-333797, the conveyance path for conveying sheets is switched by a switching portion. In addition, if a following sheet that is not multi-fed is conveyed, it is necessary to return the switching portion to the original position. However, the timing at which the trailing edge of the multi-fed sheet (e.g., the second sheet of the multi-fed two sheets) varies, depending on the amount of overlap (i.e., the amount of shift) between the multi-fed two sheets. In particular, if the switching portion is returned to the original position before the trailing edge of the multi-fed sheet (e.g., the second sheet of the multi-fed two sheets) passes through the switching portion, the second sheet may be caught between the switching portion and a guide, and stopped. In this case, the following sheet may abut against the second sheet and cause a jam.

An object of the present invention is to provide a sheet conveyance apparatus and an image forming system that can prevent the occurrence of jam while guiding the multi-fed first and second sheets to a third conveyance path.

### SUMMARY OF THE INVENTION

According to a first aspect of the present invention, a sheet conveyance apparatus includes a conveyance portion configured to convey a sheet, a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path, a multi-feeding detection portion disposed upstream of the switching portion in a sheet conveyance direction and configured to detect multi-feeding in which a first sheet and a second sheet that follows the first sheet overlap with each other, and a control portion configured to control the switching portion for guiding the first sheet and the second sheet to the third conveyance path by switching the switching portion to the second position in a case where multi-feeding is detected by the multi-feeding detection portion. In the case where multi-feeding is detected by the multi-feeding detection portion, the control portion is configured to calculate a first time at which a trailing edge of the second sheet in the sheet conveyance direction has been passed through the switching portion, and switch the switching portion from the second position to the first position at the first time.

According to a second aspect of the present invention, a sheet conveyance apparatus includes a conveyance portion configured to convey a sheet, a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path, a multi-feeding detection portion disposed upstream of the switching portion in a sheet conveyance direction and configured to detect multi-feeding in which a first sheet and a second sheet that follows the first sheet overlap with each other, a trailing-edge detection portion disposed upstream of the switching portion in the sheet conveyance direction and configured to detect a trailing edge of the second sheet in the sheet conveyance direction, and a control portion configured to control the switching portion for guiding the first sheet and the second sheet to the third conveyance path by switching the switching portion to the second position in a case where multi-feeding is detected by the multi-feeding detection portion. In the case where multi-feeding is detected by the multi-feeding detection portion, the control portion is configured to switch the switching portion from the second position to the first position based on detecting the trailing edge of the second sheet by the trailing-edge detection portion.

According to a third aspect of the present invention, an image forming system includes the sheet conveyance apparatus, and an image forming apparatus configured to form an image on the sheet conveyed from the sheet conveyance apparatus.

Further features of the present invention will become apparent from the following description of exemplary embodiments with reference to the attached drawings.

### BRIEF DESCRIPTION OF THE DRAWINGS

FIG. 1A is a block diagram illustrating a schematic configuration of an image forming system of a first embodiment.

FIG. 1B is a schematic cross-sectional view illustrating the schematic configuration of the image forming system of the first embodiment.

FIG. 2A is a schematic cross-sectional view illustrating positions of sheets in a case where a single-side printing job is performed in the image forming system of the first embodiment.

FIG. 2B is a schematic cross-sectional view illustrating positions of sheets in a case where a double-side printing job is performed in the image forming system of the first embodiment.

FIG. 3 is a schematic cross-sectional view illustrating a sheet feeding apparatus of the first embodiment.

FIG. 4 is a block diagram illustrating a control portion of the image forming system of the first embodiment.

FIG. 5 is a block diagram illustrating a control portion of the sheet feeding apparatus of the first embodiment.

FIG. 6 is a block diagram illustrating control functions of the sheet feeding apparatus of the first embodiment.

FIG. 7 is a table illustrating a conveyance-route management table of the sheet feeding apparatus of the first embodiment.

FIG. 8 is a diagram illustrating a sequence of conveyance control of the sheet feeding apparatus of the first embodiment.

FIG. 9 is a flowchart illustrating conveyance control of the sheet feeding apparatus of the first embodiment.

FIG. 10 is a flowchart illustrating multi-feeding detection control of the sheet feeding apparatus of the first embodiment.

FIG. 11 is a flowchart illustrating sheet-conveyance-path switch determination control of the sheet feeding apparatus of the first embodiment.

FIG. 12 is a flowchart illustrating switching-portion driving control of the sheet feeding apparatus of the first embodiment.

FIG. 13 is a time chart illustrating a relationship between a waveform detected by a multi-feeding detection sensor and the time.

FIG. 14A is a diagram illustrating a case where a switching portion can be switched after multi-fed sheets have passed through the switching portion in the sheet feeding apparatus.

FIG. 14B is a diagram illustrating a case where the switching portion cannot be switched after multi-fed sheets have passed through the switching portion in the sheet feeding apparatus.

FIG. 15 is a schematic cross-sectional view illustrating a sheet feeding apparatus of a second embodiment.

FIG. 16 is a flowchart illustrating conveyance control of the sheet feeding apparatus of the second embodiment.

### DESCRIPTION OF THE EMBODIMENTS

### First Embodiment

Hereinafter, a first embodiment for embodying the present invention will be described with reference to the accompanying drawings. In the first embodiment, the description will be made for a case where an ink-jet recording system is used as an image forming system 1.

### Ink-Jet Recording System

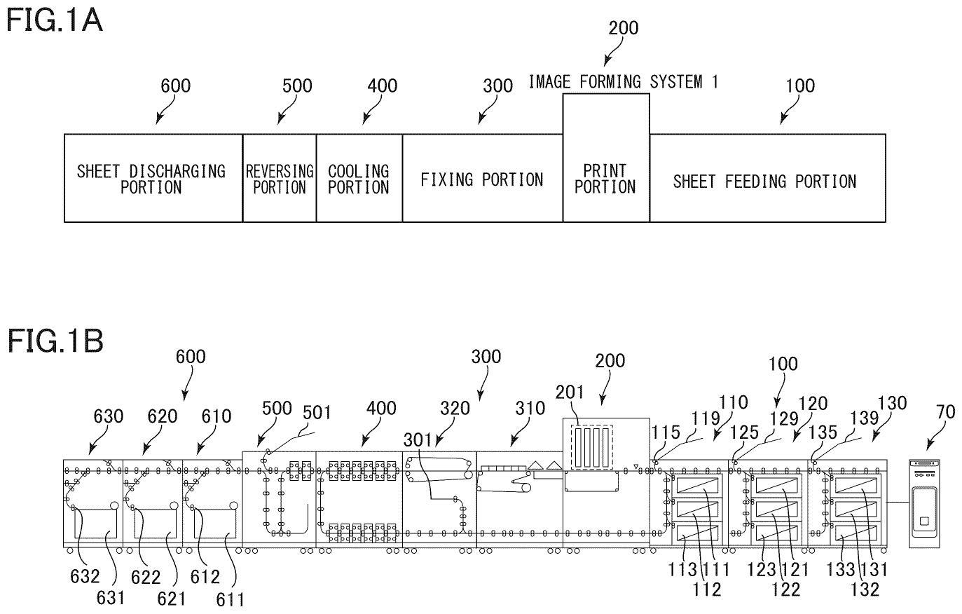

First, a schematic configuration of the image forming system 1 of the first embodiment will be described with reference to FIGS. 1A and 1B. FIG. 1A is a block diagram illustrating a schematic configuration of the image forming system of the first embodiment. FIG. 1B is a schematic cross-sectional view illustrating the schematic configuration of the image forming system of the first embodiment. The image forming system 1 is a sheet-fed ink-jet recording system that forms an ink image on a sheet or a paper sheet (that is, produces a recorded product) by using two liquids: reaction liquid and ink. In the present embodiment, the sheet is a plain paper sheet, a thin paper sheet, a thick paper sheet, or a coated paper sheet. However, the sheet is not limited to the above-described sheets, and may be another sheet or a sheet made of a material other than paper. In addition, in the present embodiment, feeding of sheets is referred to as sheet feeding, and discharging of sheets is referred to as sheet discharging. The material of the sheet is not necessarily limited to paper.

As illustrated in FIG. 1A, the image forming system 1 is constituted by six units: a sheet feeding portion 100, a print portion 200 that serves as an image forming apparatus, a fixing portion 300, a cooling portion 400, a reversing portion 500, and a sheet discharging portion 600.

As illustrated in FIG. 1B, in the sheet feeding portion 100 that serves as a feeding portion that feeds sheets in the present embodiment, three sheet feeding apparatus 110, sheet feeding apparatus 120, and sheet feeding apparatus 130 that serve as sheet conveyance apparatuses are connected (linked) with each other. The sheet feeding apparatus 110 is a unit that includes sheet feeding trays, and includes a first sheet-feeding tray 111, a second sheet-feeding tray 112, and a third sheet-feeding tray 113 that serve as a three-tier support portion. The first sheet-feeding tray 111, the second sheet-feeding tray 112, and the third sheet-feeding tray 113 store various types of printing sheets used in the print process. The sheet feeding apparatus 110 further includes a sheet discharging port 115 and a sheet discharging tray 119 that can be used as a destination to which an error sheet is sent. The error sheet is a sheet that cannot be normally conveyed to the print portion 200 when a jam occurs, a multi-fed sheet, or the like. Similarly, the sheet feeding apparatus 120 includes a first sheet-feeding tray 121, a second sheet-feeding tray 122, a third sheet-feeding tray 123, a sheet discharging port 125, and a sheet discharging tray 129. The first sheet-feeding tray 121, the second sheet-feeding tray 122, and the third sheet-feeding tray 123 constitute a three-tier support portion. Furthermore, the sheet feeding apparatus 130 includes a first sheet-feeding tray 131, a second sheet-feeding tray 132, a third sheet-feeding tray 133, a sheet discharging port 135, and a sheet discharging tray 139. The first sheet-feeding tray 131, the second sheet-feeding tray 132, and the third sheet-feeding tray 133 constitute a three-tier support portion.

The print portion 200 is a unit that performs printing on a sheet, which is used for printing a print image. The print portion 200 includes an ink-jet head 201 that serves as an image forming portion. The ink-jet head 201 constitutes an image forming portion that forms an image by performing a recording process (printing). In the recording process, the ink is ejected from a plurality of recording heads to a sheet that is being conveyed. The ink is ejected from above the sheet, and adheres to the sheet.

The fixing portion 300 is a unit that performs fixing control for fixing an image printed by the print portion 200, to a sheet. The fixing portion 300 includes a drying module 310 and a fixing module 320. The drying module 310 increases the fixability between the sheet and ink by blowing warm air on the sheet and reducing the liquid component of the ink adhered to the sheet. The fixing module 320 fixes the print image to the sheet by heating the sheet, by using a plurality of heater units. The fixing portion 300 includes a sheet discharging port 301 that can be used as a destination to which an error sheet is sent.

The cooling portion 400 is a unit that performs temperature control for returning the temperature of the sheet, heated by the fixing portion 300, to a normal temperature by cooling the sheet. The cooling portion 400 cools the sheet by using a plurality of fan units.

The reversing portion 500 is a unit that performs reverse control of a sheet by switch-backing the sheet that is being conveyed. For stacking the sheet on the next-stage sheet discharging portion 600, the reversing portion 500 performs the reverse control for switching the state of the sheet between a state where the sheet is to be stacked with a printed surface serving as an upper surface, and a state where the sheet is to be stacked with the printed surface serving as a lower surface. The reversing portion 500 includes a sheet discharging port 501 that can be used as a destination to which an error sheet is sent.

The sheet discharging portion 600 is a unit that stacks printed sheets and performs sheet discharging control. In the sheet discharging portion 600, three sheet discharging apparatus 610, sheet discharging apparatus 620, and sheet discharging apparatus 630 are connected (linked) with each other. The sheet discharging apparatus 610 includes a sheet discharging stacker 611 that supports and stacks printed sheets. In addition, the sheet discharging apparatus 610 includes a sheet discharging port 612 that can be used as a destination to which a printed sheet or an error sheet is sent. Similarly, the sheet discharging apparatus 620 includes a sheet discharging stacker 621 and a sheet discharging port 622, and the sheet discharging apparatus 630 includes a sheet discharging stacker 631 and a sheet discharging port 632.

The image forming system 1 is connected with a print server 70, and a print job is sent from the print server 70. Furthermore, the print server 70 can be used for checking the state of the image forming system 1, monitoring the print job, and performing the maintenance control. Thus, a user can operate the whole of various functions of the image forming system 1.

The ink-jet head 201 of the print portion 200 is a precision portion that requires precision control. For example, if a plurality of sheets is multi-fed to the ink-jet head 201 in a state where the sheets overlap with each other, the distance between the ink-jet head 201 and the multi-fed sheets cannot be kept properly, and the sheets may contact the ink-jet head 201. In this case, the ink-jet head 201 may be damaged by the sheets. For preventing the damage of the ink-jet head 201, it is necessary to remove the multi-fed sheets on the upstream side without conveying the multi-fed sheets to the print portion 200.

### Conveyance of Sheets in Image Forming System

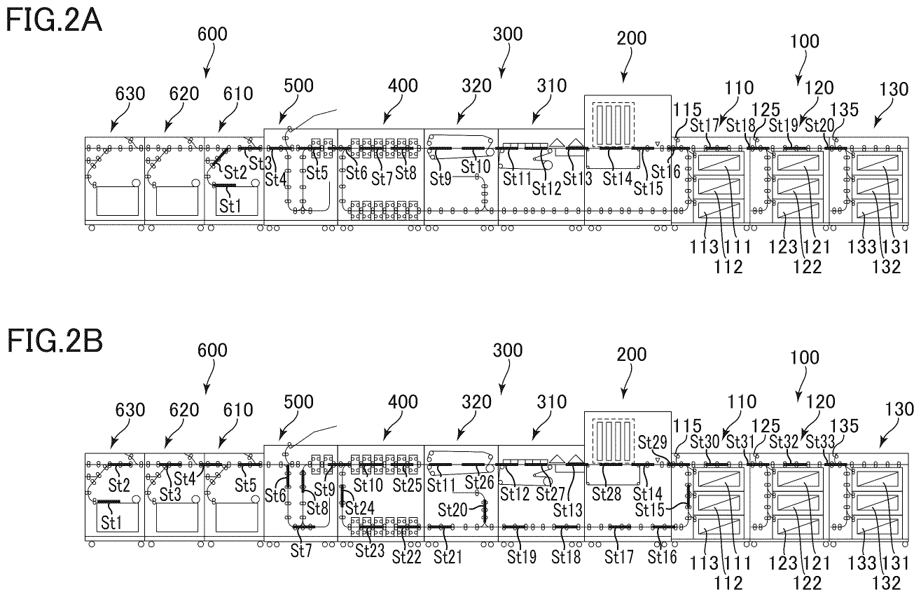

Next, conveyance of sheets in the image forming system 1 will be described with reference to FIGS. 2A and 2B. FIG. 2A is a schematic cross-sectional view illustrating positions of sheets in a case where a single-side printing job is performed in the image forming system of the first embodiment. FIG. 2B is a schematic cross-sectional view illustrating positions of sheets in a case where a double-side printing job is performed in the image forming system of the first embodiment.

As illustrated in FIG. 2A, in the execution of a print process of the single-side printing job, twenty sheets St1 to St20 are conveyed in the image forming system 1. Specifically, if a sheet is fed from the sheet feeding tray 131 of the sheet feeding apparatus 130 of the sheet feeding portion 100, the sheet is conveyed from the sheet feeding portion 100 to the print portion 200 for printing, and then conveyed sequentially through the units: the fixing portion 300, the cooling portion 400, and the reversing portion 500. The sheet conveyed from the reversing portion 500 is stacked on the sheet discharging stacker 611 of the sheet discharging apparatus 610 of the sheet discharging portion 600, as a printed sheet.

On the other hand, as illustrated in FIG. 2B, in the execution of a print process of the double-side printing job, thirty-three sheets St1 to St33 are conveyed in the image forming system 1. Specifically, if a sheet is fed from the sheet feeding tray 131 of the sheet feeding apparatus 130 of the sheet feeding portion 100, the sheet is conveyed, as in the single-side printing job, from the sheet feeding portion 100 to the print portion 200 for printing, and then conveyed sequentially through the units: the fixing portion 300, the cooling portion 400, and the reversing portion 500. A sheet with an image printed on the front side of the sheet is conveyed to a lower portion in the cooling portion 400, then conveyed sequentially through a lower portion of the fixing portion 300 and a lower portion of the print portion 200, and then returned to the sheet feeding apparatus 110 of the sheet feeding portion 100. In the lower portion of the fixing portion 300 through which the sheet is conveyed, the front side and the back side of the sheet are reversed to each other. The sheet having been returned to the sheet feeding apparatus 110 of the sheet feeding portion 100 is conveyed to the print portion 200 for performing printing on the back side (i.e., a second side) of the sheet, and in the print portion 200, the printing is performed on the back side of the sheet. After that, the sheet with images printed on both sides of the sheet is conveyed sequentially through the units: the fixing portion 300, the cooling portion 400, and the reversing portion 500, and is stacked on the sheet discharging stacker 631 of the sheet discharging apparatus 630 of the sheet discharging portion 600.

Note that in the present embodiment, the position of a sheet on which the control is performed is calculated, based on the time that has elapsed since the start of conveyance. That is, a time of a sheet calculated by a control portion of any one of units located upstream in the sheet conveyance direction is notified to a control portion of the unit, as a time at which the sheet will reach the entrance of the unit. In the present embodiment, the position (time) of a sheet is calculated, for example, by a control portion 150 of the sheet feeding apparatus 110 in the below-described control.

### Configuration of Sheet Feeding Apparatus

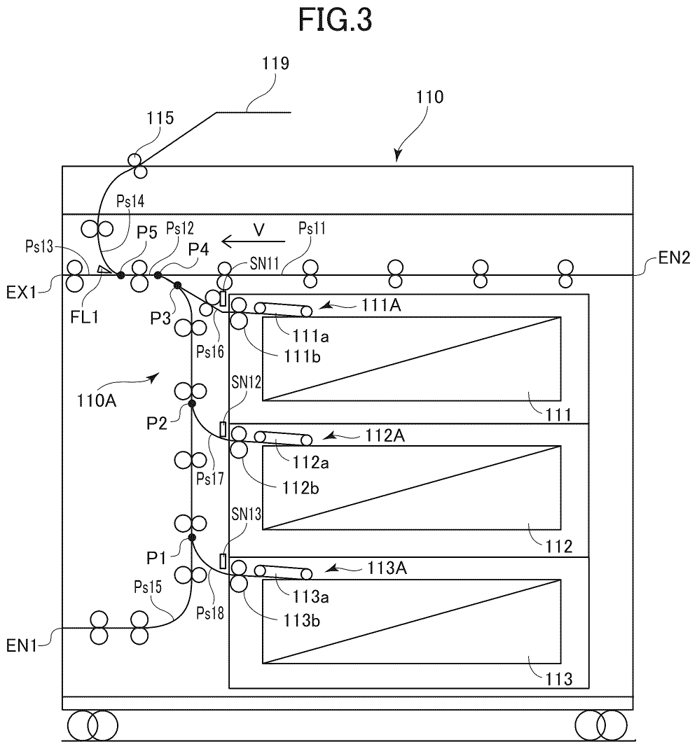

Next, a configuration of the sheet feeding apparatus 110 of the sheet feeding portion 100 will be described with reference to FIG. 3. FIG. 3 is a schematic cross-sectional view illustrating the sheet feeding apparatus of the first embodiment. Since the three sheet-feeding apparatus 110, sheet-feeding apparatus 120, and sheet-feeding apparatus 130 of the sheet feeding portion 100 of the present embodiment have the same configuration, the sheet feeding apparatus 110 of the three sheet-feeding apparatuses will be described, and the description of the sheet feeding apparatus 120 and the sheet feeding apparatus 130 will be omitted.

As illustrated in FIG. 3, the sheet feeding apparatus 110 includes the first to third sheet-feeding trays 111 to 113, which serve as a three-tier support portion. As described above, the first to third sheet-feeding trays 111 to 113 stack and store various types of printing (white) sheets used in the print process. Above each of the first sheet-feeding tray 111, the second sheet-feeding tray 112, and the third sheet-feeding tray 113, a corresponding one of sheet-feeding separation portion 111A, sheet-feeding separation portion 112A, and sheet-feeding separation portion 113A is disposed. Each of the sheet-feeding separation portions serves as a feeding portion that feeds sheets supported by a corresponding sheet feeding tray, one by one. The sheet-feeding separation portion 111A, the sheet-feeding separation portion 112A, and the sheet-feeding separation portion 113A respectively include sheet feeding belt 111a, sheet feeding belt 112a, and sheet feeding belt 113a. Each of the sheet feeding belts is driven by a motor (not illustrated), and thereby feeds the uppermost sheet floated by a fan (not illustrated) while sticking to the sheet. In addition, the sheet-feeding separation portion 111A, the sheet-feeding separation portion 112A, and the sheet-feeding separation portion 113A respectively include separation roller pair 111b, separation roller pair 112b, and separation roller pair 113b. Each of the separation roller pairs separates one sheet from the other if sheets are multi-fed by a corresponding one of the sheet feeding belt 111a, the sheet feeding belt 112a, and the sheet feeding belt 113a. Each of the separation roller pair 111b, the separation roller pair 112b, and the separation roller pair 113b is constituted by a common feed roller and a common retard roller, but may have any configuration. For example, another component, such as a separation pad, may be used in each of the separation roller pairs.

For detecting the multi-feeding of sheets, multi-feeding detection sensor SN11, multi-feeding detection sensor SN12, and multi-feeding detection sensor SN13 are disposed respectively downstream of the separation roller pair 111b, the separation roller pair 112b, and the separation roller pair 113b, in a sheet conveyance direction V. Each of the multi-feeding detection sensor SN11, the multi-feeding detection sensor SN12, and the multi-feeding detection sensor SN13 starts sensing at the leading edge of a fed sheet, and detects whether a plurality of sheets is fed simultaneously, and how much one sheet is shifted from another if the multi-feeding occurs. The detection of the multi-feeding performed by the multi-feeding detection sensor SN11, the multi-feeding detection sensor SN12, and the multi-feeding detection sensor SN13 will be described in detail below.

Next, the conveyance path of sheets in the sheet feeding apparatus 110 will be described. The sheet feeding apparatus 110 includes a horizontal-path entrance EN2 that receives a sheet conveyed from an apparatus (i.e., the sheet feeding apparatus 120) disposed upstream in the sheet conveyance direction. In addition, the sheet feeding apparatus 110 includes a sheet discharging port EX1 that discharges a sheet to an apparatus (i.e., the print portion 200) disposed downstream in the sheet conveyance direction V. Furthermore, the sheet feeding apparatus 110 includes a double-side-printing-path entrance EN1 that receives a sheet conveyed from the above-described lower portion of the print portion 200 to the sheet feeding apparatus 110 for the double-side printing. In addition, the sheet feeding apparatus 110 includes a sheet discharging tray 119 that serves as a discharging support portion. As described in detail below, the sheet discharging tray 119 is a destination to which an error sheet is sent and discharged. That is, a sheet that becomes unacceptable or invalid due to the multi-feeding or the like is discharged to the sheet discharging tray 119, and stacked on and supported by the sheet discharging tray 119. Thus, the sheet feeding apparatus 110 includes the sheet discharging port 115 that can discharge the sheet to the sheet discharging tray 119. Similarly, the sheet feeding apparatus 120 and the sheet feeding apparatus 130 respectively include the above-described sheet discharging port 125 and the sheet discharging port 135 (see FIG. 1B), from which sheets can be discharged to the sheet discharging tray 129 and the sheet discharging tray 139.

The sheet feeding apparatus 110 includes a plurality of conveyance paths that causes the horizontal-path entrance EN2, the sheet discharging port EX1, the double-side-printing-path entrance EN1, the sheet discharging port 115, and the first to third sheet-feeding trays 111 to 113 to communicate with each other, and that guides a sheet. In addition, in the conveyance paths, a plurality of conveyance roller pairs is disposed for conveying sheets. The conveyance roller pairs constitute a conveyance portion 110A that conveys sheets.

Specifically, the sheet feeding apparatus 110 includes a first horizontal-conveyance path Ps11, a second horizontal-conveyance path Ps12 that serves as a first conveyance path, and a third horizontal-conveyance path Ps13 that serves as a second conveyance path. The first horizontal-conveyance path Ps11, the second horizontal-conveyance path Ps12, and the third horizontal-conveyance path Ps13 are horizontal paths that cause the horizontal-path entrance EN2 and the sheet discharging port EX1 to communicate with each other. In addition, the first horizontal-conveyance path Ps11, the second horizontal-conveyance path Ps12, and the third horizontal-conveyance path Ps13 are disposed, one adjacent to another on a straight line in a horizontal direction. In addition, the sheet feeding apparatus 110 includes an error sheet-discharging path Ps14 that serves as a third conveyance path. The error sheet-discharging path Ps14 is branched from an error-bin branch point P5 positioned between the second horizontal-conveyance path Ps12 and the third horizontal-conveyance path Ps13, and guides a sheet to the sheet discharging port 115. At the error-bin branch point P5, a switching portion FL1 is disposed. The switching portion FL1 can be switched between a first position and a second position by pivoting the switching portion FL1. In the first position, the switching portion FL1 guides a sheet conveyed in the second horizontal-conveyance path Ps12 by the conveyance portion 110A, to the third horizontal-conveyance path Ps13. In the second position, the switching portion FL1 guides a sheet conveyed in the second horizontal-conveyance path Ps12 by the conveyance portion 110A, to the error sheet-discharging path Ps14.

In addition, the sheet feeding apparatus 110 includes a duplex conveyance path Ps15. The duplex conveyance path Ps15 causes the double-side-printing-path entrance EN1 and a horizontal-path meeting point P4 positioned between the first horizontal-conveyance path Ps11 and the second horizontal-conveyance path Ps12, to communicate with each other, and guides a sheet. In addition, the sheet feeding apparatus 110 includes a tray conveyance path Ps18 that causes the third sheet-feeding tray 113 and a third-sheet-feeding-tray meeting point P1 to communicate with each other, and guides a sheet. In addition, the sheet feeding apparatus 110 includes a tray conveyance path Ps17 that causes the second sheet-feeding tray 112 and a second-sheet-feeding-tray meeting point P2 to communicate with each other, and guides a sheet. In addition, the sheet feeding apparatus 110 includes a tray conveyance path Ps16 that causes the first sheet-feeding tray 111 and a first-sheet-feeding-tray meeting point P3 to communicate with each other, and guides a sheet.

In the sheet feeding apparatus 110 configured as described above, a sheet fed from the first sheet-feeding tray 111 by the sheet-feeding separation portion 111A is conveyed to the sheet discharging port EX1 through the tray conveyance path Ps16, the duplex conveyance path Ps15, the second horizontal-conveyance path Ps12, and the third horizontal-conveyance path Ps13. Similarly, a sheet fed from the second sheet-feeding tray 112 by the sheet-feeding separation portion 112A is conveyed to the sheet discharging port EX1 through the tray conveyance path Ps17, the duplex conveyance path Ps15, the second horizontal-conveyance path Ps12, and the third horizontal-conveyance path Ps13. Similarly, a sheet fed from the third sheet-feeding tray 113 by the sheet-feeding separation portion 113A is conveyed to the sheet discharging port EX1 through the tray conveyance path Ps18, the duplex conveyance path Ps15, the second horizontal-conveyance path Ps12, and the third horizontal-conveyance path Ps13.

In addition, a sheet conveyed from the above-described sheet feeding apparatus 120 or the sheet feeding apparatus 130 (see FIG. 1B) is conveyed to the sheet discharging port EX1 through the horizontal-path entrance EN2, the first horizontal-conveyance path Ps11, the second horizontal-conveyance path Ps12, and the third horizontal-conveyance path Ps13. In addition, a sheet conveyed from the above-described print portion 200 (see FIG. 1B) is conveyed to the sheet discharging port EX1 through the double-side-printing-path entrance EN1, the duplex conveyance path Ps15, the second horizontal-conveyance path Ps12, and the third horizontal-conveyance path Ps13.

The above-described switching portion FL1 is driven by a switching-portion driving motor (not illustrated). When power is turned on or a print job is started, the switching portion FL1 is initialized so as to guide a sheet located in the second horizontal-conveyance path Ps12, to the third horizontal-conveyance path Ps13 (i.e., the sheet discharging port EX1). If the multi-feeding detection sensor SN11, the multi-feeding detection sensor SN12, or the multi-feeding detection sensor SN13, that serves as a multi-feeding detection portion detects the multi-feeding of sheets in the tray conveyance path Ps16, the tray conveyance path Ps17, or the tray conveyance path Ps18, the switching portion FL1 is switched from the first position to the second position, and the switching portion FL1 guides a sheet located in the second horizontal-conveyance path Ps12, to the error sheet-discharging path Ps14 (i.e., the sheet discharging port 115). The detailed description of the switch control of the switching portion FL1 will be made below.

### Control Portion of Image Forming System

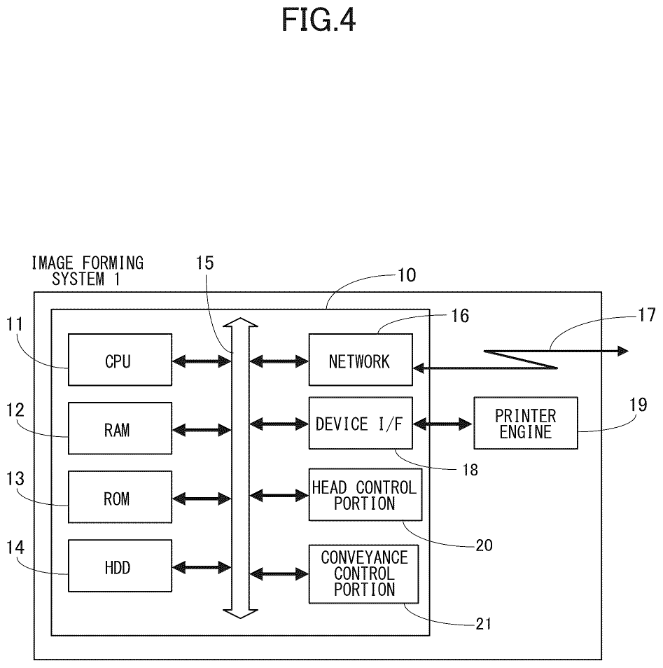

Next, a control portion 10 of the image forming system 1 will be described with reference to FIG. 4. FIG. 4 is a block diagram illustrating the control portion of the image forming system of the first embodiment.

As illustrated in FIG. 4, the image forming system 1 includes the control portion 10 that is a controller unit. The control portion 10 controls sending and receiving sensor signals and device information, and controls executing various processes of control. For example, a program in which processes are written is stored in a ROM 13 or an HDD 14, and installed in the image forming system 1. A CPU 11 of the control portion 10 reads the program stored in the ROM 13 or the HDD 14, from the ROM 13 or the HDD 14; stores the program in a RAM 12; and executes the program. In addition, the CPU 11 collectively controls the devices connected to a system bus 15. The RAM 12 functions as a main memory or a work memory of the CPU 11. The ROM 13 stores a boot program executed when power is turned on, and the HDD 14 stores an operating system and a control program of the system. The HDD 14 is also used for storing large data temporarily or for a long time.

A Network 16 is connected to a local area network 17, and sends/receives data or device information to/from an external apparatus. The program may be installed in the ROM 13 or the HDD 14 via the Network 16. A device I/F 18 is an interface portion between the CPU 11 and a printer engine 19, and sends/receives signals for operating or referring to various motors, sensors, and the ink-jet head connected to the printer engine 19. The printer engine 19 is an ink-jet output device that conveys a printing sheet, depending on the control from the control portion 10, and that outputs an image sent from the print server 70, onto a printing sheet by controlling the ink-jet head 201 (see FIG. 1B). A head control portion 20 controls the ink-jet head 201 of the printer engine 19 via the device I/F 18, and performs the control, such as ink-ejection control for the image formation and head retraction control performed when an improper sheet is detected. A conveyance control portion 21 controls conveyance motors and sensors for feeding a printing sheet from the sheet feeding portion 100, conveying the sheet in synchronization with an ink ejection timing of the ink-jet head 201, and discharging the sheet to the sheet discharging portion 600.

Note that the description has been made for the case where the control portion 10 (i.e., a controller unit) is a single unit. However, a plurality of controller units may be used, separated from each other, and each of the sheet feeding portion 100, the print portion 200, the fixing portion 300, the cooling portion 400, the reversing portion 500, and the sheet discharging portion 600 may include a corresponding one of the controller units. In this case, a specific controller unit collectively controls the other controller units.

### Control Portion of Sheet Feeding Apparatus

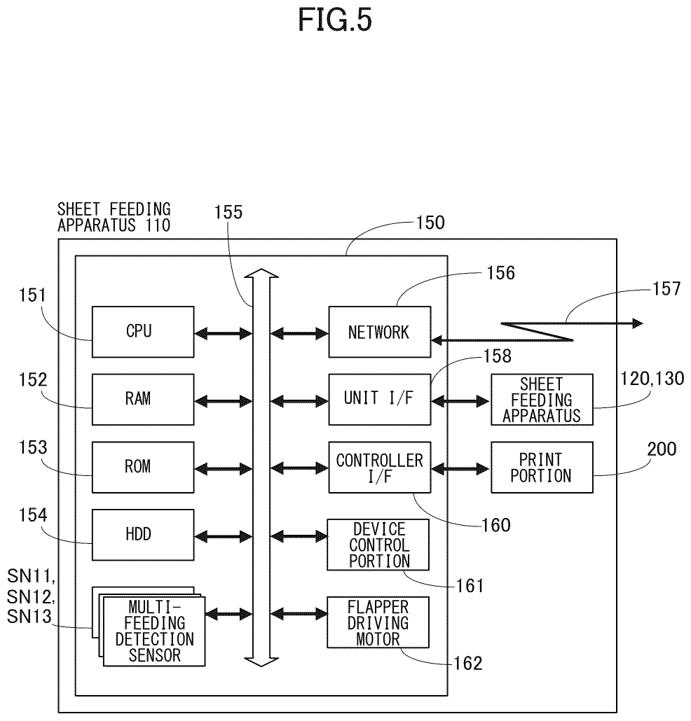

Next, a configuration of a control portion 150 of the sheet feeding apparatus 110 will be described with reference to FIG. 5. FIG. 5 is a block diagram illustrating the control portion of the sheet feeding apparatus of the first embodiment. The description will be made for a case where the sheet feeding apparatus 110, the sheet feeding apparatus 120, and the sheet feeding apparatus 130 of the sheet feeding portion 100 include corresponding control portions (i.e., controller units) separated from each other, and where the control portion 150 of the sheet feeding apparatus 110 is one of the control portions. That is, each of the sheet feeding apparatus 120 and the sheet feeding apparatus 130 includes a control portion identical to the control portion 150. In this configuration, even in a case where the sheet feeding portion 100 includes three apparatuses (units) identical to each other, connected in series with each other, and serving as sheet feeding units (that is, three sheet feeding apparatuses identical to each other and connected in series with each other), the system can be built easily.

As illustrated in FIG. 5, the sheet feeding apparatus 110 includes the control portion 150 that is a controller unit. The control portion 150 controls sending and receiving sensor signals and device information, and controls executing various processes of control. For example, a program in which processes are written is stored in a ROM 153 or an HDD 154, and installed in the sheet feeding apparatus 110. A CPU 151 reads the program stored in the ROM 153 or the HDD 154, from the ROM153 or the HDD154; stores the program in a RAM 152; and executes the program. In addition, the CPU 151 collectively controls the devices connected to a system bus 155. The RAM 152 functions as a main memory or a work memory of the CPU 151. The ROM 153 stores a boot program executed when power is turned on, and the HDD 154 stores an operating system and a control program of the apparatus. The HDD 154 is also used for storing large data temporarily or for a long time.

A Network 156 is connected to a local area network 157, and sends/receives data or device information to/from an external apparatus. The program may be installed in the ROM 153 or the HDD 154 via the Network 156. A unit I/F 158 is an interface portion between the CPU 151 and an apparatus disposed adjacent to the sheet feeding apparatus 110. In the present embodiment, the unit I/F 158 is connected to the sheet feeding apparatus 120 (i.e., the control portion of the sheet feeding apparatus 120) connected to the sheet feeding apparatus 110. A controller I/F 160 is an interface portion between the controller and the print portion 200, and is connected with the print portion 200 of the image forming system 1 (i.e., the control portion of the print portion 200). A device control portion 161 controls sheet feeding fans for feeding printing sheets from the first to third sheet-feeding trays 111 to 113, and controls conveyance motors and sensors for conveying sheets to the downstream apparatus or the sheet discharging tray 119 (see FIG. 3). As described above, each of the multi-feeding detection sensor SN11, the multi-feeding detection sensor SN12, and the multi-feeding detection sensor SN13 detects the multi-feeding of sheets fed from a corresponding one of the sheet-feeding separation portion 111A, the sheet-feeding separation portion 112A, and the sheet-feeding separation portion 113A. A switching-portion driving motor 162 (FLAPPER DRIVING MOTOR) drives the switching portion FL1 for switching the above-described position of the switching portion FL1.

### Control Functions of Sheet Feeding Apparatus

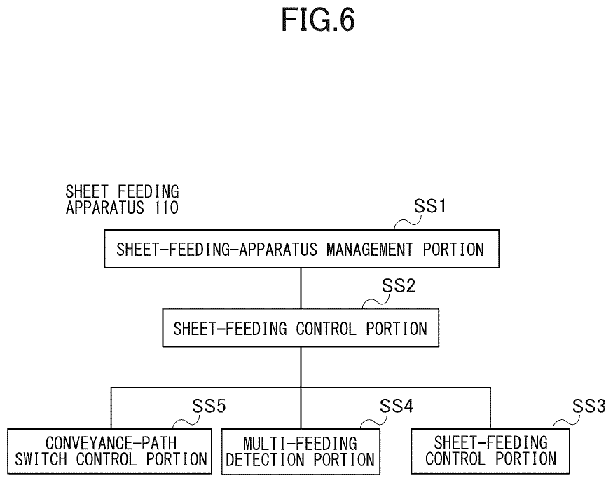

Next, control functions achieved by the control portion 150 of the above-described sheet feeding apparatus 110 performing various types of control (processes) will be described with reference to FIG. 6. FIG. 6 is a block diagram illustrating the control functions of the sheet feeding apparatus of the first embodiment. Note that the control portion of each of the sheet feeding apparatus 120 and the sheet feeding apparatus 130 also has the same control functions as those illustrated in FIG. 6. Each component illustrated in FIG. 6 and serving as a software module functions such that the component is stored in the HDD 154, as a program, then loaded into the RAM 152, and then executed by the CPU 151.

A sheet-feeding-apparatus management portion SS1 sends/receives print-job information and instructions or responses to/from the print portion 200 via the controller I/F 160, and collectively controls the components of the sheet feeding apparatus 110. Upon receiving a request for conveying a sheet (i.e., a request for feeding a sheet or a request for conveying a sheet in the double-side printing), the sheet-feeding-apparatus management portion SS1 sends an instruction for conveying a sheet, to a conveyance control portion SS2. The conveyance control portion SS2 sends an instruction to a sheet-feeding control portion SS3, a multi-feeding detection portion SS4, or a conveyance-path switch control portion SS5 in accordance with a conveyance route of the above-described conveyance paths. That is, while sending an instruction to each of the control portions, the conveyance control portion SS2 performs the control for conveying a sheet to be fed or a sheet conveyed from one adjacent apparatus, to another adjacent apparatus (i.e., the print portion 200) disposed downstream in the conveyance direction V, or to the sheet discharging port 115 in accordance with a sheet conveyance time.

The sheet-feeding control portion SS3 controls the sheet-feeding separation portion 111A, the sheet-feeding separation portion 112A, and the sheet-feeding separation portion 113A; and feeds sheets, one by one, stacked on each of the sheet feeding tray 111, the sheet feeding tray 112, and the sheet feeding tray 113. The multi-feeding detection portion SS4 causes the multi-feeding detection sensor SN11, the multi-feeding detection sensor SN12, and the multi-feeding detection sensor SN13 to sense sheets fed from the corresponding sheet feeding tray 111, the corresponding sheet feeding tray 112, and the corresponding sheet feeding tray 113. That is, each of the multi-feeding detection sensor SN11, the multi-feeding detection sensor SN12, and the multi-feeding detection sensor SN13 detects whether sheets are multi-fed, and how much a plurality of sheets that overlap with each other is shifted from each other in the conveyance in the conveyance direction V if the sheets are multi-fed. The conveyance-path switch control portion SS5 switches the destination of sheets to the sheet discharging port 115 by switching the switching portion FL1 in a case where the multi-feeding of sheets has been detected or the sheets that are being conveyed have become unacceptable due to another error. In this case, the sheets are determined as error sheets. The switching portion FL1 is switched by driving the switching-portion driving motor 162.

### Conveyance-Route Management Table

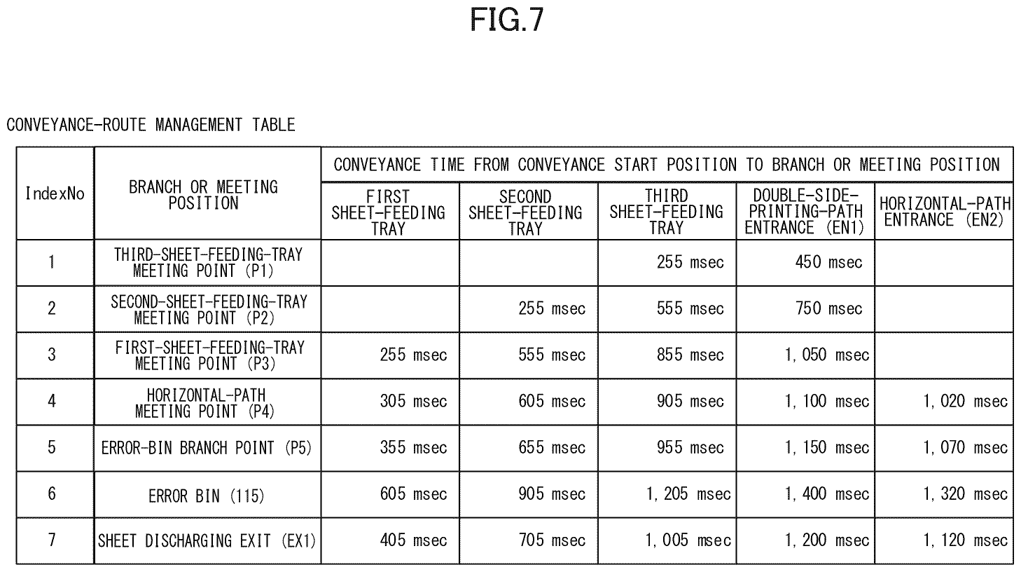

Next, a conveyance-route management table included in the control portion 150 of the sheet feeding apparatus 110 will be described with reference to FIG. 7. FIG. 7 is a table illustrating the conveyance-route management table of the sheet feeding apparatus of the first embodiment.

In the conveyance of a sheet, there is a case where the sheet is conveyed from the conveyance start position of each component to the sheet discharging port (an error bin) past a branch position and a meeting position. For managing the time at which the sheet passes the branch position and the meeting position, in the conveyance-route management table, each position and a corresponding passage time are recorded, associated with each other, as illustrated in FIG. 7. Note that in the present embodiment, the position of a sheet which is conveyed and on which the control is performed is calculated, based on the time that has elapsed since the start of conveyance.

The conveyance-route management table contains information on the Index-No, information on the branch or meeting position, and information on the conveyance time from a conveyance start position to a branch or meeting position. The Index-No is an identifier for uniquely identifying the conveyance route information. The branch or meeting position is the name of the branch position (P5) and the meeting positions (P1, P2, P3, and P4) (see FIG. 3). The conveyance time from a conveyance start position to a branch or meeting position is a conveyance time taken from a conveyance start position (0 mm) that is the first sheet-feeding tray 111, the second sheet-feeding tray 112, the third sheet-feeding tray 113, the double-side-printing-path entrance EN1, or the horizontal-path entrance EN2. That is, the conveyance time from a conveyance start position to a branch or meeting position is a time taken for a sheet to move from the conveyance start position to the branch or meeting position, which are positioned on the conveyance path for discharging the sheet to the target sheet-discharging destination. That is, the conveyance-route management table contains information on the time at which a sheet conveyed from each conveyance start position reaches a branch or meeting position. Thus, the time at which a sheet passes a point on the conveyance path can be calculated from the information contained in the conveyance-route management table, and from the time which is notified from the control portion 10 of the print portion 200 and at which the sheet is located in the conveyance start position.

### Sequence for Feeding and Conveying Sheets

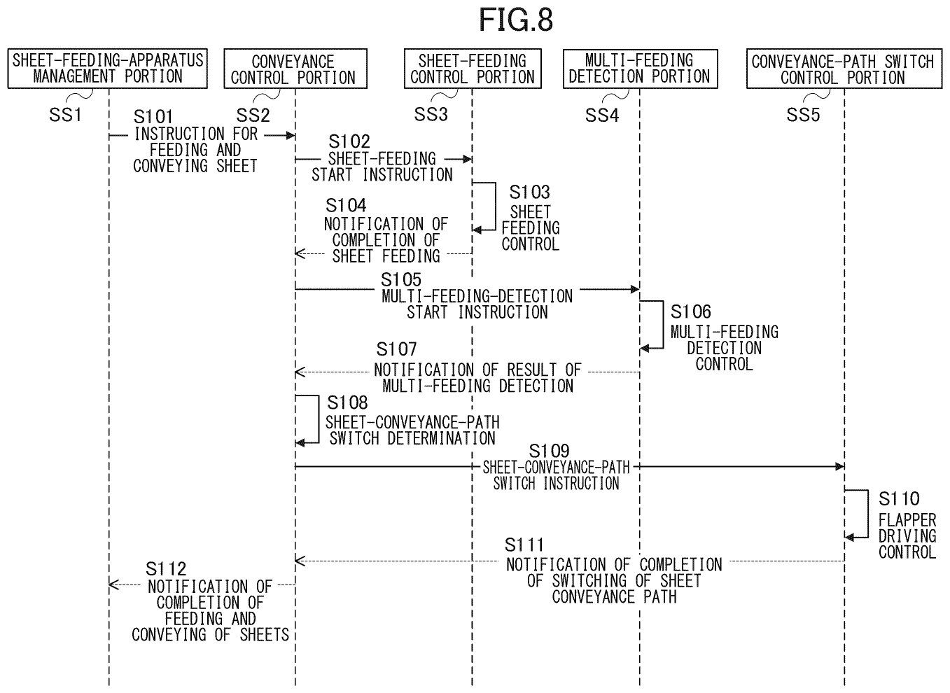

Next, an overall sequence of the sheet feeding apparatus 110 used for feeding sheets, one by one, stacked on the first to third sheet-feeding trays 111 to 113 will be described with reference to FIG. 8. FIG. 8 is a diagram illustrating the sequence of conveyance control of the sheet feeding apparatus of the first embodiment.

As illustrated in FIG. 8, if the sheet-feeding-apparatus management portion SS1 receives a conveyance request from the print portion 200, the sequence is started after the sheet-feeding-apparatus management portion SS1 initializes the switching portion FL1 (that is, moves the switching portion FL1 to a home position at which the switching portion FL1 guides a sheet to the sheet discharging port EX1) and drives the fans for feeding a sheet. The conveyance request notified contains information on a sheet feeding tray from which a sheet is to be fed, and information on the sheet-conveyance start time.

In Step S101, the sheet-feeding-apparatus management portion SS1 notifies the conveyance control portion SS2 of an instruction for feeding and conveying a sheet. In Step S102, the conveyance control portion SS2 notifies the sheet-feeding control portion SS3 of the instruction for feeding and conveying a sheet. When the conveyance control portion SS2 notifies the sheet-feeding control portion SS3 of the instruction for feeding and conveying a sheet, the conveyance control portion SS2 also notifies the sheet-feeding control portion SS3 of the sheet-conveyance start time.

In Step S103, the sheet-feeding control portion SS3 causes the sheet-feeding separation portion of a specified sheet feeding tray to perform the sheet feeding control. That is, the sheet-feeding separation portion rotates the fan for floating a sheet, and performs the sheet feeding operation by driving the sheet feeding belt if the sheet-conveyance start time is reached. In Step S104, the sheet-feeding control portion SS3 notifies the conveyance control portion SS2 of the completion of feeding a sheet. The notification may be performed after Step S105.

In Step S105, the conveyance control portion SS2 notifies the multi-feeding detection portion SS4 of a multi-feeding-detection start instruction. When the conveyance control portion SS2 notifies the multi-feeding detection portion SS4 of the multi-feeding-detection start instruction, the conveyance control portion SS2 also notifies the multi-feeding detection portion SS4 of the time at which the leading edge of a fed sheet will pass the multi-feeding detection sensor. In Step S106, the multi-feeding detection portion SS4 performs the below-described multi-feeding detection control.

In Step S107, the multi-feeding detection portion SS4 notifies the conveyance control portion SS2 of a result of the multi-feeding detection. The notification contains information on whether the multi-feeding has occurred, and an elapsed time in which the leading edge of the sheet has moved when the multi-feeding is detected. In Step S108, the conveyance control portion SS2 performs below-described sheet-conveyance-path switch determination.

In Step S109, the conveyance control portion SS2 notifies the conveyance-path switch control portion SS5 of a sheet-conveyance-path switch instruction, if necessary. When the conveyance control portion SS2 notifies the conveyance-path switch control portion SS5 of the sheet-conveyance-path switch instruction, the conveyance control portion SS2 notifies the conveyance-path switch control portion SS5 of a switch start time of the switching portion FL1 and a return start time that serves as a first time. In Step S110, the conveyance-path switch control portion SS5 performs below-described switching-portion driving control (FLAPPER DRIVING CONTROL). In Step S111, the conveyance-path switch control portion SS5 notifies the conveyance control portion SS2 of the completion of switching the sheet conveyance path.

If the conveyance of the sheet to the sheet discharging port EX1 or the discharging of the sheet to the sheet discharging port 115 is completed, the conveyance control portion SS2 notifies the sheet-feeding-apparatus management portion SS1 of the completion of feeding and conveying the sheet, in Step S112. In the above-described sequence, the processes for feeding and conveying sheets are performed.

### Control of Sheet Feeding Apparatus of First Embodiment

Hereinafter, the control of the sheet feeding apparatus of the present embodiment will be described in detail with reference to a flowchart. The following description will be made for a case where the control is performed by the CPU 151 of the control portion 150 of the sheet feeding apparatus 110. However, the control may be performed by a CPU of any one of the control portions of the sheet feeding apparatuses. In particular, the control may be performed by the CPU 11 of the control portion 10 of the image forming system 1. In addition, in the following description, the first sheet that a sheet feeding tray starts to feed is referred to as a sheet S1, the second sheet following the first sheet and multi-fed is referred to as a sheet S2, and a sheet conveyed from an upstream apparatus so as to follow the sheet S1 or S2 is referred to as a sheet S3.

### Conveyance Control

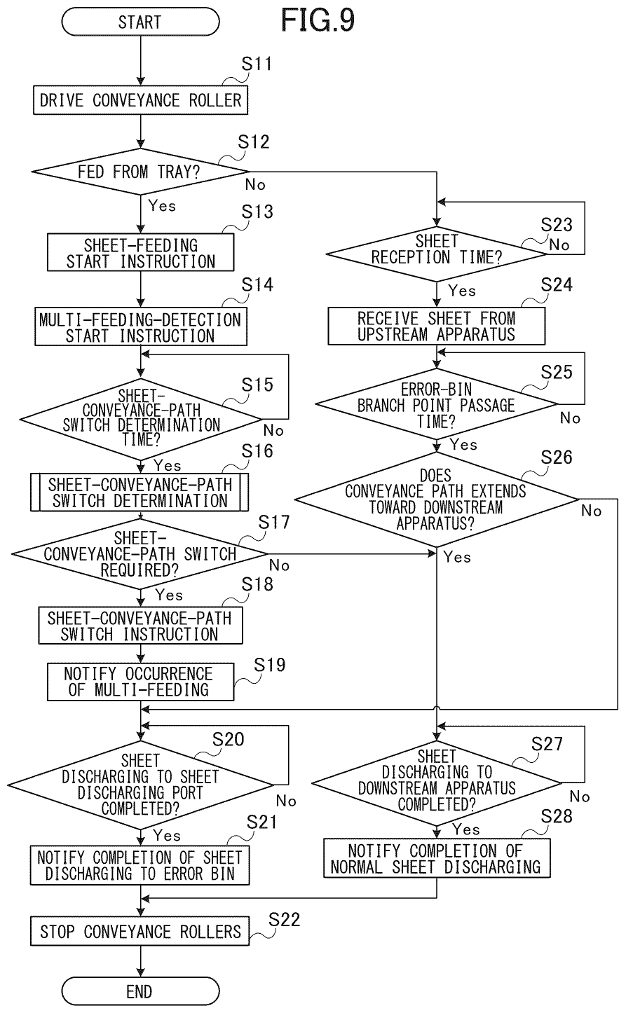

First, the conveyance control of the sheet feeding apparatus of the first embodiment will be described with reference to FIG. 9. FIG. 9 is a flowchart illustrating the conveyance control of the sheet feeding apparatus of the first embodiment. In the following description of the flowchart, an instruction or a notification is equivalent to setting ON or OFF in a flag (involved with a corresponding process) of the control portion 150 of the sheet feeding apparatus 110 or a control portion of another apparatus. If the flag is set in accordance with the instruction or the notification, any process involved with the flag that has been set can be started, or any image can be displayed by a display (not illustrated).

As described above, if the conveyance control portion SS2 receives, in Step S101, an instruction for feeding and conveying a sheet, from the sheet-feeding-apparatus management portion SS1, the conveyance control of the sheet feeding apparatus is started. As illustrated in FIG. 9, the CPU 151 then drives a conveyance roller of each component of the conveyance portion 110A (S11). Then the CPU 151 determines whether the instruction for feeding and conveying a sheet is an instruction for feeding a sheet from any one of the first sheet-feeding tray 111, the second sheet-feeding tray 112, and the first sheet-feeding tray 113, or an instruction for receiving a sheet conveyed from an upstream apparatus (i.e., another sheet feeding apparatus or the print portion 200) disposed upstream in the conveyance direction V (S12). The CPU 151 proceeds to Step S13 if the instruction for feeding and conveying a sheet is an instruction for feeding a sheet from any one of the first sheet-feeding tray 111, the second sheet-feeding tray 112, and the first sheet-feeding tray 113, or proceeds to Step S23 if the instruction for feeding and conveying a sheet is an instruction for receiving a sheet conveyed from the upstream apparatus.

If the CPU 151 proceeds to Step S13, then the CPU 151 notifies the sheet-feeding control portion SS3 of a sheet-feeding start instruction. When the CPU 151 notifies the sheet-feeding control portion SS3 of the sheet-feeding start instruction, the CPU 151 notifies the sheet-feeding control portion SS3 (i.e., the sheet-feeding separation portion) of information that, for example, contains the data: “cassette ID: second sheet-feeding cassette, sheet-conveyance start time: 12:10:30 and 000 milliseconds” (the sheet-conveyance start time, 12:10:30 and 000 milliseconds, is hereinafter abbreviated as 30.000). Upon receiving the sheet-feeding start instruction, the sheet-feeding control portion SS3 performs a process for feeding a sheet, and starts to feed the sheet from the second sheet- feeding tray 112 at the sheet-conveyance start time of 30.000.

Then the CPU 151 notifies the multi-feeding detection portion SS4 (i.e., the multi-feeding detection sensor) of a multi-feeding-detection start instruction (S14). When the CPU 151 notifies the multi-feeding detection portion SS4 of the multi-feeding-detection start instruction, the CPU 151 notifies the multi-feeding detection portion SS4 of information that, for example, contains the data: “sensor ID: multi-feeding detection sensor SN12, detection start time: 30.150, detection end time: 30.570” if an A3-size sheet (whose length is 420 mm) is conveyed at a speed of 1000 mm/s. The detection start time is determined as described above because the leading edge of the fed sheet passes the multi-feeding detection sensor SN12 when 150 msec has elapsed since the sheet conveyance time. The detection end time is determined, based on a time of 420 msec in which the sheet having a length of 420 mm passes through the multi-feeding detection sensor SN12 (the time of period in which the detection is performed may be determined based on the sheet length, or may be determined based on another parameter). Upon receiving the multi-feeding-detection start instruction, the multi-feeding detection portion SS4 performs a process for detecting the multi-feeding, and starts the detection of the multi-feeding at the detection start time of 30.150. The detection of the multi-feeding will be described in detail below.

Then the CPU 151 determines whether a sheet-conveyance-path switch determination time is reached, for conveying the sheet S1 fed from the sheet feeding tray (S15). In the present embodiment, the CPU 151 determines that the sheet-conveyance-path switch determination time is reached, when the leading edge of the sheet S1 reaches the horizontal-path meeting point (P4) (that is, at a time at which 605 msec has elapsed since the start of conveyance of the sheet S1 from the second sheet-feeding cassette) (see FIG. 7). Thus, the CPU 151 determines whether the arrival time of 30.605 is reached. If the arrival time is not reached, then the CPU 151 repeats the process until the arrival time is reached (S15: No). If the arrival time is reached (S15: Yes), then the CPU 151 proceeds to Step S16. In Step S16, the CPU 151 performs sheet-conveyance-path switch determination. The sheet-conveyance-path switch determination will be described in detail below.

If the CPU 151 determines, based on the result of the sheet-conveyance-path switch determination, that it is necessary to switch the sheet conveyance path (S17: Yes), then the CPU 151 proceeds to Step S18. If the CPU 151 determines that it is unnecessary to switch the sheet conveyance path (S17: No), then the CPU 151 proceeds to Step S27. If the CPU 151 proceeds to Step S18, then the CPU 151 notifies the conveyance-path switch control portion SS5 of a sheet-conveyance-path switch instruction. When the CPU 151 notifies the conveyance-path switch control portion SS5 of the sheet-conveyance-path switch instruction, the CPU 151 notifies the conveyance-path switch control portion SS5 of information that, for example, contains the data: “switch start time: 30.615, return start time: 31:145”. The data is created, depending on the result of the sheet-conveyance-path switch determination. Upon receiving the information, the conveyance-path switch control portion SS5 switches the switching portion FL1.

Then the CPU 151 notifies the sheet-feeding-apparatus management portion SS1 of the occurrence of multi-feeding (S19). In addition, the occurrence of multi-feeding is notified to the print portion 200 via the sheet-feeding-apparatus management portion SS1. The notification may be performed when the sheet is discharged to the sheet discharging port 115. However, if the notification is performed earlier, the following sheet can be stopped earlier, and the operation of the print portion 200 can be stopped or changed earlier.

Then the CPU 151 determines whether the sheets (i.e., the multi-fed sheet S1 and the multi-fed sheet S2 in the present embodiment) are discharged to the sheet discharging port 115 (S20). The completion of discharging sheets may be determined based on time. In another case, a sensor for monitoring the conveyance of sheets may be disposed in the vicinity of the sheet discharging port 115, and the sensor may monitor the passage of the trailing edge of the sheet S2. The sheet-discharging completion time can be calculated by adding the time at which the leading edge of the sheet S1 reaches the sheet discharging port 115 (when 905 msec has elapsed since the start of conveyance of the sheet S1 from the second sheet-feeding cassette) (see FIG. 7), with a time that corresponds to a length of a multi-fed sheet (including the below-described amount of shift). If the sheet discharging is not completed (S20: No), then the CPU 151 repeats the process until the sheet discharging is completed. If the sheet discharging is completed (S20: Yes), then the CPU 151 proceeds to Step S21.

If the CPU 151 proceeds to Step S21, then the CPU 151 notifies the conveyance control portion SS2 of the completion of discharging the sheets to the error bin (i.e., the sheet discharging port 115). With this operation, the CPU 151 stops the sheet discharging roller (S22), and ends the conveyance control of the sheet feeding apparatus 110.

On the other hand, if the instruction for feeding and conveying a sheet is, in Step S12, an instruction for receiving a sheet conveyed from the above-described upstream apparatus, then the CPU151 proceeds to Step S23. If the CPU 151 proceeds to Step S23, then the CPU 151 determines whether a sheet reception time is reached. The CPU 151 repeats the process if the sheet reception time is not reached (S23: No), or proceeds to Step S24 if the sheet reception time is reached (S23: Yes). If the CPU 151 proceeds to Step S24, then the CPU 151 receives the sheet S3 from the upstream apparatus.

Then the CPU 151 determines whether a passage time at which the sheet S3 received from the upstream apparatus passes the error-bin branch point (P5) is reached (S25). The CPU 151 repeats the process if the passage time is not reached (S25: No), or proceeds to Step S26 if the passage time is reached (S25: Yes).

In Step S26, the CPU 151 determines whether the direction of the conveyance path extends toward a downstream apparatus disposed downstream in the conveyance direction V (i.e., the print portion 200, the sheet feeding apparatus 110 if the sheet is fed from the sheet feeding apparatus 120, or the sheet feeding apparatus 120 if the sheet is fed from the sheet feeding apparatus 130). That is, the CPU 151 determines whether the switching portion FL1 is positioned in the first position that is an initial position. If the direction of the conveyance path extends toward the downstream apparatus (S26: Yes), then the CPU 151 proceeds to Step S27.

If it is not necessary to switch the sheet conveyance path in Step S17 (S17: No), or the direction of the conveyance path extends toward the downstream apparatus (S26: Yes), then the CPU 151 proceeds to Step S27. Then the CPU 151 determines whether the sheet (i.e., the sheet S1 or S3 in the present embodiment) is discharged to the downstream apparatus. The completion of discharging the sheet to the downstream apparatus may be determined based on time. In another case, a sensor for monitoring the conveyance of sheets may be disposed in the vicinity of the sheet discharging port EX1, and the sensor may monitor the passage of the trailing edge of the sheet S1 or S3. The sheet-discharging completion time can be calculated by adding the time at which the leading edge of the sheet reaches the sheet discharging port EX1 (when 705 msec has elapsed since the start of conveyance of the sheet S1 from the second sheet-feeding cassette, for example) (see FIG. 7), with a time that corresponds to a length of the sheet. If the sheet discharging is not completed (S27: No), then the CPU 151 repeats the process until the sheet discharging is completed. If the sheet discharging is completed (S27: Yes), then the CPU 151 proceeds to Step S28. If the CPU 151 proceeds to Step S28, then the CPU 151 notifies the conveyance control portion SS2 of the completion of normally delivering the sheet S1 or S3 to the downstream apparatus, and proceeds to Step S22. With this operation, the CPU 151 stops the sheet discharging roller (S22), and ends the conveyance control of the sheet feeding apparatus 110.

On the other hand, if the direction of the conveyance path does not extend toward the downstream apparatus in the above-described Step S26 (S26: No), that is, if the switching portion FL1 has been switched from the first position to the second position and the direction of the conveyance path extends toward the sheet discharging port 115, then the CPU 151 proceeds to Step S20. In this case, the preceding sheet S1 and S2 have been multi-fed, and the sheet S3 conveyed from the upstream apparatus has reached the switching portion FL1 before the switching portion FL1 is returned to the first position, because the amount of shift is large. Thus, in this case, the switching portion FL1 cannot be returned to the first position.

Also in a case where the CPU 151 proceeds to Step S20 in this manner, the CPU 151 determines whether the sheets (i.e., the sheets S1 to S3) are discharged to the sheet discharging port 115, as described above (S20). If the sheet discharging is not completed (S20: No), then the CPU 151 repeats the process until the sheet discharging is completed. If the sheet discharging is completed (S20: Yes), then the CPU 151 notifies the conveyance control portion SS2 of the completion of discharging the sheets to the error bin (i.e., the sheet discharging port 115). With this operation, the CPU 151 stops the sheet discharging roller (S22), and ends the conveyance control of the sheet feeding apparatus 110.

Note that in the above-described conveyance control of the sheet feeding apparatus 110, the plurality of conveyance rollers that serve as the conveyance portion 110A is collectively driven or stopped. However, only necessary conveyance rollers may be driven or stopped in a sequential manner by calculating the time at which the sheet reaches a corresponding component.

### Multi-Feeding Detection Control

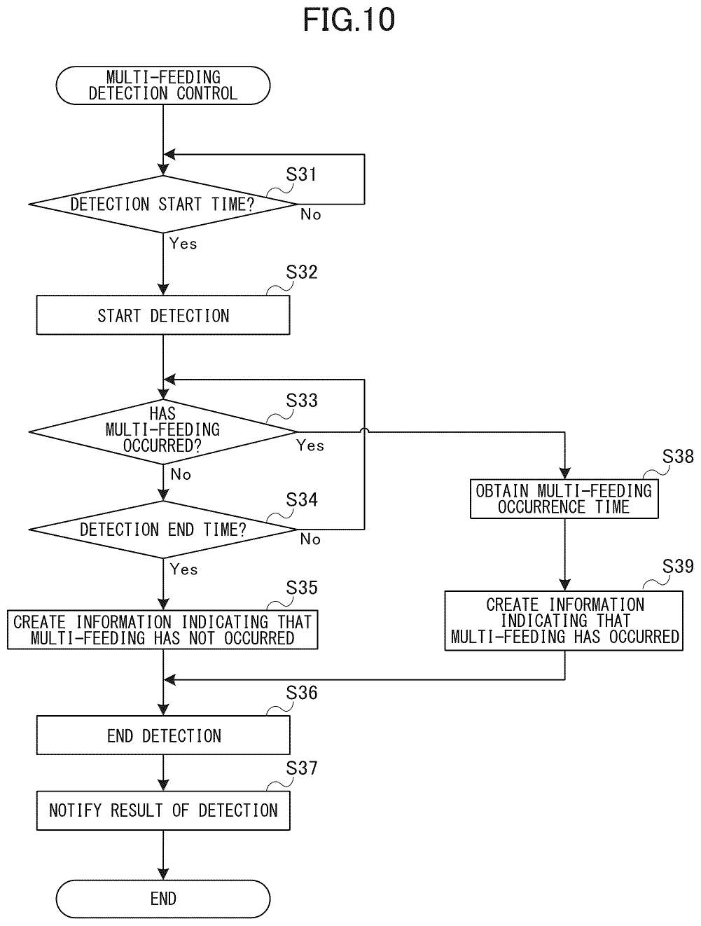

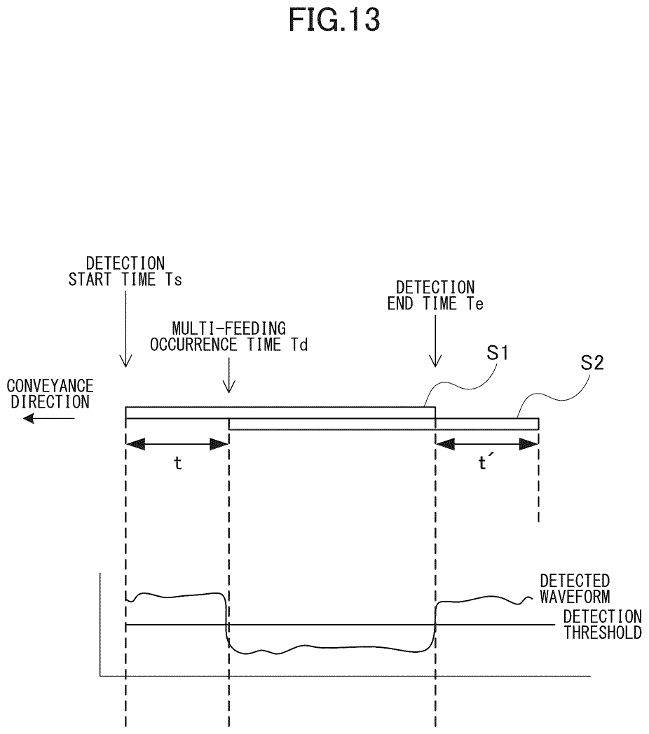

Next, the multi-feeding detection control of the sheet feeding apparatus of the first embodiment will be described with reference to FIGS. 10 and 13. FIG. 10 is a flowchart illustrating the multi-feeding detection control of the sheet feeding apparatus of the first embodiment. FIG. 13 is a time chart illustrating a relationship between a waveform detected by a multi-feeding detection sensor and the time.

First, the relationship between a waveform detected by the multi-feeding detection sensor and the time will be described. As illustrated in FIG. 13, the second sheet S2 following the preceding first sheet S1 is conveyed, overlapped with the first sheet S1. That is, the second sheet S2 is conveyed, multi-fed. In a case where the sheet S1 and the sheet S2 are conveyed, shifted from each other, a detection start time Ts is a time at which the leading edge of the sheet S1 passes the multi-feeding detection sensor, and a multi-feeding occurrence time Td is a time at which the leading edge of the sheet S2 reaches the multi-feeding detection sensor. In a case where an ultrasonic multi-feeding-detection sensor is used, if the sheets are conveyed, shifted from each other, the waveform of an overlapping portion of the sheets detected by the sensor decreases in level. Thus, if the level of the waveform becomes lower than a predetermined detection threshold, the CPU 151 determines the occurrence of multi-feeding. A multi-feeding shift time t that corresponds to the amount of shift between the sheet S1 and the sheet S2 can be calculated by subtracting the detection start time Ts from the multi-feeding occurrence time Td. In other words, the multi-feeding shift time t is a length of time from the time when the leading edge of the sheet S1 is detected, to the time when the multi-feeding is detected. The multi-feeding shift time t corresponds to a conveyance time t′ by which the conveyance time is extended because the conveyance length of the total of the multi-fed sheet S1 and the multi-fed sheet S2 becomes larger than the conveyance length of the sheet S1. For example, if the detection start time Ts is 30.150 and the multi-feeding occurrence time Td is 30.220, the sheet has moved 70 msec when the multi-feeding is detected (that is, the sheet has moved by 70 mm if the speed is 1000 mm/s). The time difference is the multi-feeding shift time t that corresponds to the amount of shift between the multi-fed sheets.

Next, the multi-feeding detection control of the sheet feeding apparatus of the first embodiment will be described. If the CPU 151 proceeds to Step S14 (see FIG. 9) of the above-described conveyance control of the sheet feeding apparatus, the multi-feeding detection portion SS4 receives the multi- feeding-detection start instruction from the conveyance control portion SS2 (S105), so that the CPU 151 starts the detection control of the sheet feeding apparatus. In the present embodiment, the description will be made, as an example, for a case where the multi-feeding detection portion SS4 receives the information: “sensor ID: multi-feeding detection sensor SN12, detection start time: 30.150, detection end time: 30.570”.

As illustrated in FIG. 10, if the CPU 151 starts the multi-feeding detection control, then the CPU 151 determines whether the detection start time Ts (i.e., 30.150) for the multi-feeding is reached (S31). If the detection start time Ts is not reached (S31: No), then the CPU 151 repeats the process until the detection start time Ts is reached. If the detection start time Ts is reached (S31: Yes), then the CPU 151 starts the multi-feeding detection (S32).

Then the CPU 151 determines whether the multi-feeding has occurred (S33). The CPU 151 proceeds to Step S34 if the multi-feeding has not occurred (S33: No), or proceeds to Step S38 if the multi-feeding has occurred (S33: Yes). If the CPU 151 proceeds to Step S34, then the CPU 151 determines whether a detection end time Te (i.e., 30.570) for the multi-feeding is reached. If the detection end time Te is not reached (S34: No), then the CPU 151 returns to Step S33, and waits while repeating the steps S33 to S34. If the detection end time Te is reached (S34: Yes), then the CPU 151 proceeds to Step S35. Then the CPU 151 creates information indicating that the multi-feeding has not occurred (S35), ends the multi-feeding detection (S36), and notifies the conveyance control portion SS2 of the detection result (S37). With these operations, the CPU 151 ends the multi-feeding detection control.

On the other hand, if the CPU 151 determines in the above-described Step S33 that the multi-feeding has occurred (S33: Yes), then the CPU 151 proceeds to Step S38 and obtains the multi-feeding occurrence time Td. Then the CPU 151 creates information indicating that the multi-feeding has occurred (S39). This information contains the multi-feeding shift time t (70 msec) that corresponds to the time by which the conveyance length is extended due to the multi-feeding in which one sheet is fed together with another sheet. For example, the CPU 151 creates the information: “multi-feeding: occurred, multi-feeding shift time: 70 msec”. Then the CPU 151 ends the multi-feeding detection (S36), and notifies the conveyance control portion SS2 of the detection result (S37). With these operations, the CPU 151 ends the multi-feeding detection control.

### Sheet-Conveyance-Path Switch Determination Control

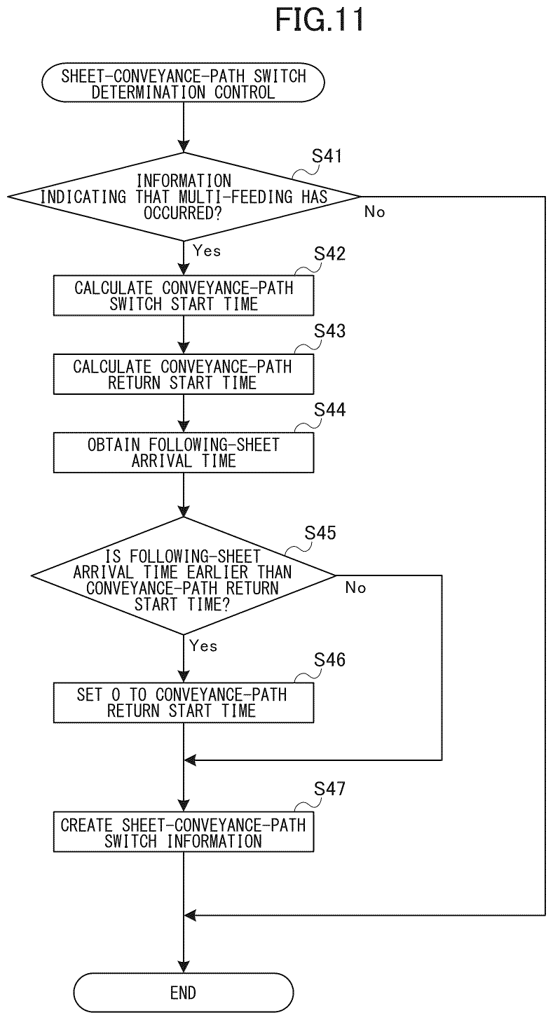

Next, the sheet-conveyance-path switch determination control of the sheet feeding apparatus of the first embodiment will be described with reference to FIG. 11. FIG. 11 is a flowchart illustrating the sheet-conveyance-path switch determination control of the sheet feeding apparatus of the first embodiment.

If the CPU 151 proceeds to Step S16 (see FIG. 9) of the above-described conveyance control of the sheet feeding apparatus, then the CPU 151 starts the sheet-conveyance-path switch determination control, and determines whether the result of the multi-feeding detection indicates that the multi-feeding has occurred (S41). If the result of the multi-feeding detection indicates that the multi-feeding has not occurred (S41: No), then the CPU 151 ends the process. On the other hand, if the result of the multi-feeding detection indicates that the multi-feeding has occurred (S41: Yes), then the CPU 151 proceeds to Step S42.

Then the CPU 151 calculates a conveyance-path switch start time (S42). For example, it takes 40 msec (obtained by adding a switching-portion driving time 30 msec with a margin 10 msec) to switch the conveyance path. The time at which the leading edge of the sheet S1 reaches the error-bin branch point (P5) is 30.655 (that is, the leading edge of the sheet S1 reaches the error-bin branch point when 655 msec has elapsed since the start of conveyance of the sheet S1 from the second sheet-feeding cassette) (see FIG. 7). Thus, the conveyance-path switch start time is 30.615 obtained by subtracting 40 msec, taken for switching the conveyance path, from the time at which the leading edge of the sheet S1 reaches the error-bin branch point (P5).

Then the CPU 151 calculates a conveyance-path return start time (S43). That is, the CPU 151 calculates a time at which the trailing edge of the following sheet S2 of the multi-fed sheet S1 and the multi-fed sheet S2 passes through the error-bin branch point (P5). In the present embodiment, two examples will be described.

Example 1 is a case where the result of the multi-feeding detection indicates that the multi-feeding has occurred in the conveyance of A3 sheets, and where the multi-feeding shift time is 0 msec.

In this example,
sheet length: 420 mm (A3 size),
sheet conveyance speed: 1000 mm/s, and
multi-feeding shift time: 0 msec.

Example 2 is a case where the result of the multi-feeding detection indicates that the multi-feeding has occurred in the conveyance of A3 sheets, and where the multi-feeding shift time is 70 msec.

In this example,
sheet length: 420 mm (A3 size),
sheet conveyance speed: 1000 mm/s, and
multi-feeding shift time: 70 msec.

In Example 1, the time at which the trailing edge of the following sheet S2 passes through the error-bin branch point (P5) is 31.075 obtained by adding the time 30.655 at which the leading edge of the sheets reaches the error-bin branch point (P5), with the time 420 msec taken for the trailing edge of the sheets to pass through the error-bin branch point (P5). In Example 2, the time at which the trailing edge of the following sheet S2 passes through the error-bin branch point (P5) is obtained by further adding the time at which the trailing edge of the following A3 sheet S2 passes through the error-bin branch point (P5), with the multi-feeding shift time 70 msec. Thus, the time at which the trailing edge of the following sheet S2 passes through the error-bin branch point (P5) is 31.145.

Then the CPU 151 obtains a following-sheet arrival time that serves as a third time (S44). That is, the CPU 151 obtains the time at which the sheet S3 that follows the multi-fed sheet S1 and the multi-fed sheet S2 reaches the error-bin branch point (P5), from the conveyance-route management table (see FIG. 7). That is, if the sheet S3 for the double-side printing is conveyed from the double-side-printing-path entrance EN1 (i.e., the print portion 200), the CPU 151 obtains, as the following-sheet arrival time, the conveyance time from the double-side-printing-path entrance EN1 to the error-bin branch point (P5), from the conveyance-route management table. In addition, if the sheet S3 is conveyed from the horizontal-path entrance EN2 (i.e., the sheet feeding apparatus 120), the CPU 151 obtains, as the following-sheet arrival time, the conveyance time from the horizontal-path entrance EN2 to the error-bin branch point (P5), from the conveyance-route management table.

Then the CPU 151 determines whether the following-sheet arrival time, obtained as described above, is earlier than the conveyance-path return start time calculated in Step S43 (S45). The CPU 151 proceeds to Step S46 if the following-sheet arrival time is earlier than the conveyance-path return start time (S45: Yes), or proceeds to Step S47 if the following-sheet arrival time is not earlier than the conveyance-path return start time (S45: No).

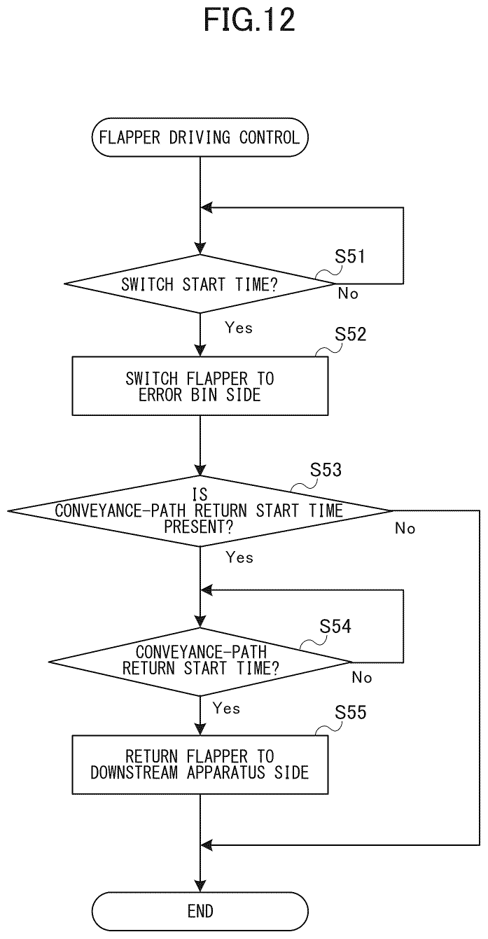

In Step S46, the CPU 151 sets 0 to the conveyance-path return start time. If the CPU 151 sets 0 to the conveyance-path return start time, the switching portion FL1 keeps the conveyance path switched to the sheet discharging port 115 side (see Step S53 of FIG. 12 described below). That is, the CPU 151 cancels the operation for returning the switching portion FL1 to the first position that is the initial position, and keeps the position (i.e., the second position) of the switching portion FL1. In this case, if the CPU 151 returns the switching portion FL1 to the first position, a jam may occur. This is because the leading edge of the following sheet S3 has already passed through the switching portion FL1 (i.e., the error-bin branch point P5) and entered the error sheet-discharging path Ps14 before the trailing edge of the sheet S2 passes through the switching portion FL1.

After that, if the CPU 151 proceeds to Step S47, then the CPU 151 creates sheet-conveyance-path switch information. In the case where the result of the multi-feeding detection indicates that the multi-feeding has occurred, and where the multi-feeding shift time is 70 msec, the sheet-conveyance-path switch information contains the data: “switch start time: 30.615, return start time: 31.145”. With the completion of creating the sheet-conveyance-path switch information, the CPU 151 ends the sheet-conveyance-path switch determination control.

In the present embodiment, the control is performed under the condition in which the sheet conveyance speed at which the sheet is conveyed in the multi-feeding detection and the sheet conveyance speed at which the sheet passes through the switching portion FL1 are both 1000 mm/s. However, if the speed varies, the return start time may be calculated in consideration of the difference in speed. For example, in a case where the sheet conveyance speed at which the sheet passes through the switching portion FL1 is 1400 mm/s, the multi-feeding shift time can be calculated as 50 msec (i.e., 70 msec×1000/1400=50 msec).

### Switching-Portion Driving Control

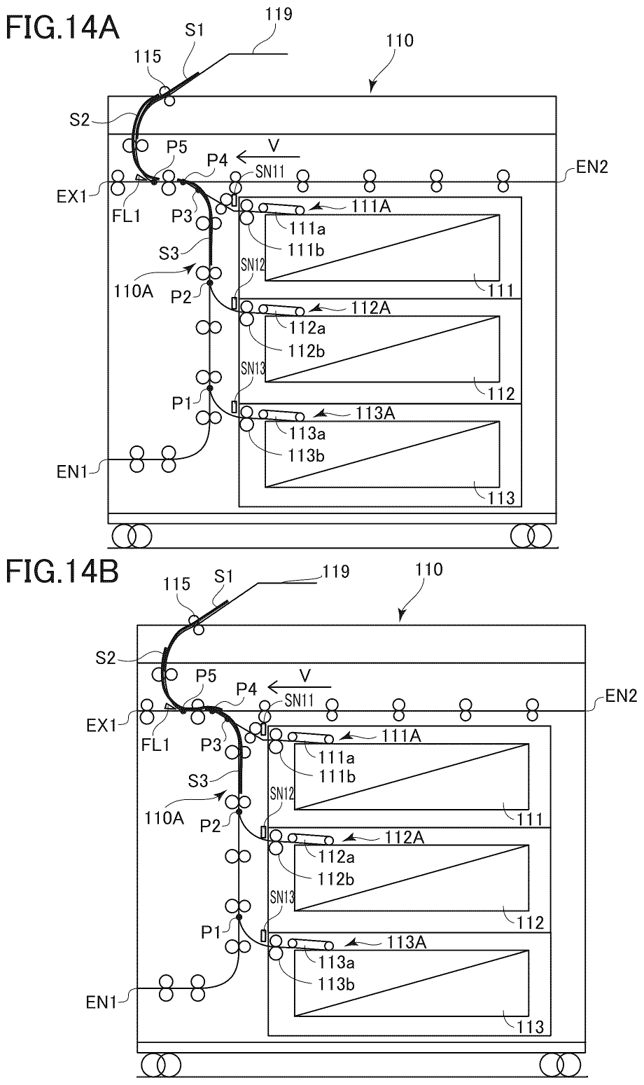

Next, the switching-portion driving control of the sheet feeding apparatus of the first embodiment will be described with reference to FIGS. 12, 14A, and 14B. FIG. 12 is a flowchart illustrating the switching-portion driving control of the sheet feeding apparatus of the first embodiment. FIG. 14A is a diagram illustrating a case where the switching portion can be switched after multi-fed sheets have passed through the switching portion in the sheet feeding apparatus. FIG. 14B is a diagram illustrating a case where the switching portion cannot be switched after multi-fed sheets have passed through the switching portion in the sheet feeding apparatus.

If the CPU 151 proceeds to Step S18 (see FIG. 9) of the above-described conveyance control of the sheet feeding apparatus, the conveyance-path switch control portion SS5 receives the sheet-conveyance-path switch instruction from the conveyance control portion SS2 (S109), so that the CPU 151 starts the switching-portion driving control of the sheet feeding apparatus. In the present embodiment, the description will be made for a case where the conveyance-path switch control portion SS5 receives information that, for example, contains the data: “switch start time: 30.615, return start time: 31.145”.

If the CPU 151 starts the switching-portion driving control, then the CPU 151 determines whether the switch start time (i.e., 30.615) is reached (S51). The CPU 151 repeats the process if the switch start time is not reached (S51: No), or proceeds to Step S52 if the switch start time is reached (S51: Yes).

Then the CPU 151 switches the switching portion FL1 (Flapper) from the first position that is an initial position, to the second position. That is, the CPU 151 switches the conveyance path, along which the sheet S1 and the sheet S2 are conveyed, to the error bin side (S52). Then the CPU 151 determines whether the return start time is contained in the information (S53). In a case where the return start time is not contained in the information, the conveyance-path switch control portion SS5 is notified of only the switch start time. For example, in this case, the sheet-conveyance-path switch information contains the data: “switch start time: 30.615, return start time: 0”. If the return start time is not contained in the information (S53: No), then the CPU 151 ends the switching-portion driving control. Specifically, the CPU 151 cancels the switching of the switching portion FL, and keeps the second position of the switching portion FL1. That is, the CPU 151 does not switch the conveyance path to the downstream apparatus side, on which side the sheet is discharged to the downstream apparatus.

That is, if it is determined in the above-described Step S45 (see FIG. 11) that the following-sheet arrival time is earlier than the conveyance-path return start time, and that the following sheet S3 reaches the switching portion FL1 before the trailing edge of the sheet S2 of the multi-fed sheets passes through the switching portion FL1, the return start time is not contained in the information (see S46). In this case, as illustrated in FIG. 14B, the leading edge of the following sheet S3 reaches the switching portion FL1 before the trailing edge of the sheet S2 of the fed-sheet S1 and the fed-sheet S2 passes through the switching portion FL1. If the switching portion FL1 is switched and returned to the first position at the timing at which the leading edge of the following sheet S3 reaches the switching portion FL1 before the trailing edge of the sheet S2 of the fed-sheet S1 and the fed-sheet S2 passes through the switching portion FL1, the following sheet S3 will be caught by the switching portion FL1 and a jam will occur. For this reason, the switching of the switching portion FL1 is canceled, and the switching portion FL1 is not switched. As a result, the following sheet S3 is also discharged to the sheet discharging tray 119, so that the occurrence of jam can be prevented. In the present embodiment, after the switching of the switching portion FL1 is canceled, the CPU 151 stops the conveyance rollers (see S22), and ends the conveyance control. However, the multi-fed sheet S1, the multi-fed sheet S2 and the following sheet S3 may be automatically recovered and fed.

On the other hand, if the return start time is contained in the information in the above-described Step S53 (S53: Yes), then the CPU 151 proceeds to Step S54. If the CPU 151 proceeds to Step S54, then the CPU 151 determines whether the return start time (i.e., 31.145) is reached. The CPU 151 repeats the process if the return start time is not reached (S54: No), or proceeds to Step S55 if the return start time is reached (S54: Yes).

Then the CPU 151 switches the switching portion FL1 (Flapper) from the second position to the first position that is an initial position. That is, the CPU 151 switches the conveyance path to the downstream apparatus side (S55), and ends the switching-portion driving control.

That is, in this case, it is determined that the following-sheet arrival time is not earlier than the conveyance-path return start time, and that the following sheet reaches the switching portion FL1 after the trailing edge of the sheet S2 of the multi-fed sheets passes through the switching portion FL1. Thus, as illustrated in FIG. 14A, the leading edge of the following sheet S3 reaches the switching portion FL1 after the trailing edge of the sheet S2 of the fed-sheet S1 and the fed-sheet S2 passes through the switching portion FL1. If the switching portion FL1 is switched and returned to the first position at the timing at which the leading edge of the following sheet S3 reaches the switching portion FL1 after the trailing edge of the sheet S2 of the fed-sheet S1 and the fed-sheet S2 passes through the switching portion FL1, the sheet S2 will not be caught by the switching portion FL1, causing no jam, and the following sheet S3 will also not be caught by the switching portion FL1, causing no jam. In short, in addition to making it possible to discharge the sheet S1 and the sheet S2 to the sheet discharging tray 119 and the following sheet S3 to the print portion 200 that is a downstream apparatus, the occurrence of jam can be prevented. In the present embodiment, after the switching portion FL1 is switched to the first position, the CPU 151 stops the conveyance rollers (see S22), and ends the conveyance control.

However, the multi-fed sheet S1 and the multi-fed sheet S2 may be automatically recovered and fed.

### Summary of First Embodiment

As described above, if the sheet S1 and the sheet S2 are multi-fed, there is a case where the sheet S1 and the sheet S2 overlap with each other, shifted from each other. In this case, the trailing edge of the sheet S2 passes through (reaches) the switching portion FL1, delayed from the trailing edge of the sheet S1 by the amount of shift. However, in the sheet feeding apparatus 110, the control portion 150 (i.e., the CPU 151) calculates the conveyance-path return start time at which the trailing edge of the sheet S2 passes through the switching portion FL1, in a case where the multi-feeding detection sensor detects the multi-feeding. In addition, the control portion 150 switches the switching portion FL1 from the second position to the first position at the conveyance-path return start time. With this operation, the multi-fed sheet S1 and the multi-fed sheet S2 can be appropriately guided to the error sheet-discharging path Ps14, and the switching portion FL1 can be switched after the trailing edge of the sheet S2 passes through the switching portion FL1. As a result, the occurrence of jam can be prevented.

In addition, in a case where the multi-feeding detection sensor detects the multi-feeding, the control portion 150 switches the switching portion FL1 from the second position to the first position in accordance with the amount of shift (i.e., the multi-feeding shift time t) between the leading edge of the sheet S1 and the leading edge of the sheet S2 in the conveyance direction V. With this operation, the control portion 150 can switch the switching portion FL1 after the trailing edge of the sheet S2 passes through the switching portion FL1.

In addition, the control portion 150 calculates the conveyance-path return start time by adding the second time at which the trailing edge of the sheet S1 passes through the switching portion FL1, with the length of time from the time when the multi-feeding detection sensor detects the leading edge of the sheet S1, to the time when the multi-feeding detection sensor detects the multi-feeding. That is, the control portion 150 calculates the conveyance-path return start time by adding the detection end time Te with a time (i.e., the multi-feeding shift time t) from the detection start time Ts to the multi-feeding occurrence time Td illustrated in FIG. 13. With this operation, the control portion 150 can calculate the time at which the trailing edge of the sheet S2 passes through the switching portion FL1, as the conveyance-path return start time.

In addition, in a case where the sheet S3 is conveyed following the sheet S2, and where the following-sheet arrival time at which the leading edge of the sheet S3 passes through the switching portion FL1 is earlier than the conveyance-path return start time, the control portion 150 cancels the switching of the switching portion FL1 to be performed at the conveyance-path return start time. With this operation, it is prevented that the switching portion FL1 is switched after the leading edge of the sheet S3 passes through the switching portion FL1. As a result, the occurrence of jam caused by the sheet S3 being caught by the switching portion FL1 can be prevented.

In addition, in a case where the switching portion FL1 is positioned in the first position in the sheet feeding apparatus 110, the sheet can be guided to the third horizontal-conveyance path Ps13, along which the sheet is conveyed to the ink-jet head 201 that forms an image. If multi-fed sheets are conveyed to the ink-jet head 201 that forms an image by using the ink-jet system, the ink-jet head 201 may be damaged by the multi-fed sheets. In the sheet feeding apparatus 110, however, the switching portion FL1 is switched appropriately, so that the multi-fed sheets are not conveyed to the ink-jet head 201. As a result, the damage of the ink-jet head 201 can be prevented. In particular, since the sheet feeding apparatus 110 can cause the switching portion FL1 to guide and discharge the multi-fed sheets to the sheet discharging tray 119, the error sheets can be removed.

### Second Embodiment

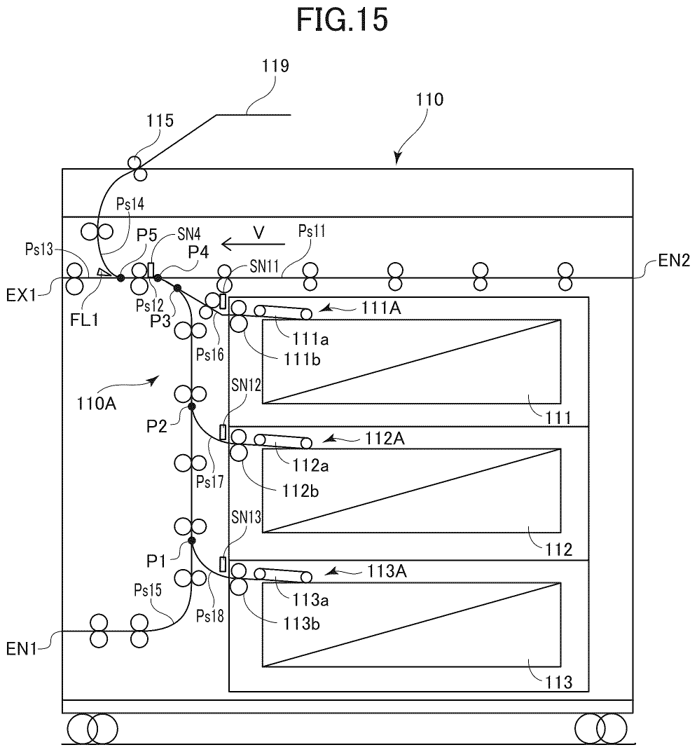

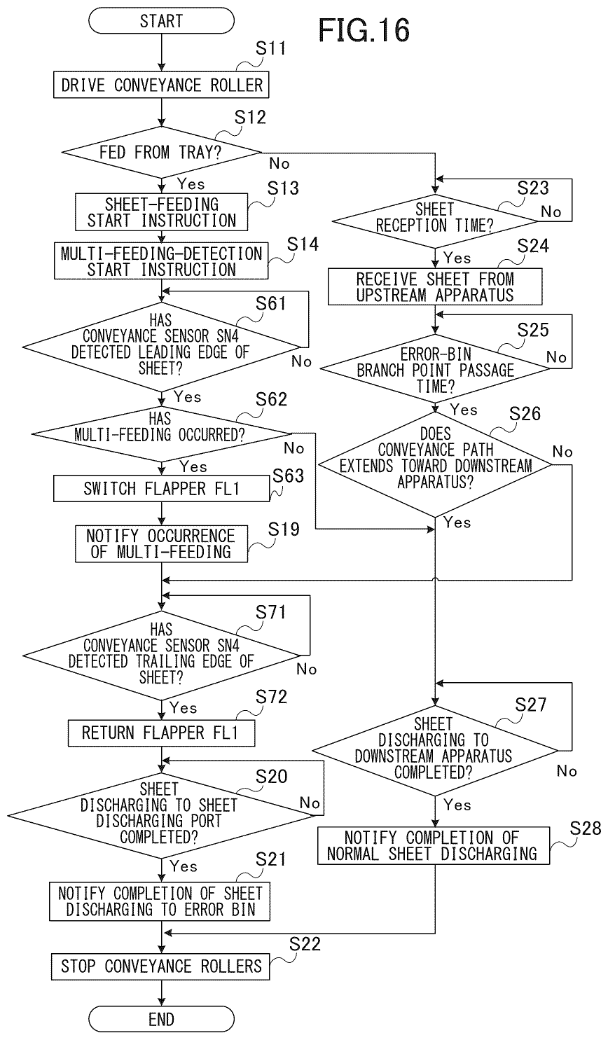

Next, a second embodiment will be described with reference to FIGS. 15 and 16. In the second embodiment, part of the first embodiment is changed. FIG. 15 is a schematic cross-sectional view illustrating a sheet feeding apparatus of the second embodiment. FIG. 16 is a flowchart illustrating the conveyance control of the sheet feeding apparatus of the second embodiment. Note that in the description of the second embodiment, a component identical to a component of the above-described first embodiment is given an identical symbol, and the description thereof will be omitted.

In the above-described first embodiment, the description has been made for the case where the time at which the trailing edge of the sheet S2 of the multi-fed sheets passes through the switching portion FL1 is calculated. In the second embodiment, however, a conveyance sensor SN4 is disposed on the second horizontal-conveyance path Ps12, as a trailing-edge detection portion that detects the trailing edge of the sheet S2.

Specifically, as illustrated in FIG. 15, the sheet feeding apparatus 110 of the second embodiment includes the conveyance sensor SN4 that conveys the sheet that passes through the second horizontal-conveyance path Ps12. That is, the conveyance sensor SN4 is disposed upstream of the switching portion FL1 (i.e., the error-bin branch point P5) in the conveyance direction V, and downstream of the horizontal-path meeting point P4 in the conveyance direction V. The conveyance sensor SN4 detects the trailing edge of the sheet S2 when the multi-fed sheet S1 and the multi-fed sheet S2 passes through the conveyance sensor SN4. Preferably, the conveyance sensor SN4 is disposed upstream of the switching portion FL1, spaced from the switching portion FL1 by a predetermined distance in consideration of the response time from the time when the trailing edge of the sheet S2 is detected by the conveyance sensor SN4, to the time when the switching portion FL1 is driven.

### Control of Sheet Feeding Apparatus of Second Embodiment

Next, control of the sheet feeding apparatus of the second embodiment, in particular, conveyance control in the second embodiment will be described with reference to FIG. 16. Note that the conveyance control of the second embodiment differs from the conveyance control of the first embodiment (see FIG. 9) in the steps S61 to S63 and S71 to S72, and the other steps of the conveyance control of the second embodiment are substantially the same as those of the conveyance control of the first embodiment.

As in the above-described first embodiment, if the conveyance control portion SS2 receives, in Step S101, an instruction for feeding and conveying a sheet, from the sheet-feeding-apparatus management portion SS1, the conveyance control of the sheet feeding apparatus is started. Then, as illustrated in FIG. 16, the CPU 151 drives the conveyance roller (S11). Then the CPU 151 determines whether the instruction for feeding and conveying a sheet is an instruction for feeding a sheet from any one of the first to third sheet-feeding trays 111 to 113, or an instruction for receiving the sheet S3 conveyed from an upstream apparatus (i.e., another sheet feeding apparatus or the print portion 200) disposed upstream in the conveyance direction V (S12). The CPU 151 proceeds to Step S13 if the instruction for feeding and conveying a sheet is an instruction for feeding a sheet from any one of the first to third sheet-feeding trays 111 to 113, or proceeds to Step S23 if the instruction for feeding and conveying a sheet is an instruction for receiving the sheet S3 conveyed from the upstream apparatus.

If the CPU 151 proceeds to Step S13, then the CPU 151 notifies the sheet-feeding control portion SS3 of a sheet-feeding start instruction. When the CPU 151 notifies the sheet-feeding control portion SS3 of the sheet-feeding start instruction, the CPU 151 notifies the sheet-feeding control portion SS3 (i.e., the sheet-feeding separation portion) of information that, for example, contains the data: “cassette ID: second sheet-feeding cassette, sheet-conveyance start time: 12:10:30 and 000 milliseconds” (the sheet-conveyance start time, 12:10:30 and 000 milliseconds, is hereinafter abbreviated as 30.000). Upon receiving the sheet-feeding start instruction, the sheet-feeding control portion SS3 performs a process for feeding a sheet, and starts to feed the sheet from the second sheet-feeding tray 112 at the sheet-conveyance start time of 30.000.

Then the CPU 151 notifies the multi-feeding detection portion SS4 (i.e., the multi-feeding detection sensor) of a multi-feeding-detection start instruction (S14). When the CPU 151 notifies the multi-feeding detection portion SS4 of the multi-feeding-detection start instruction, the CPU 151 notifies the multi-feeding detection portion SS4 of information that, for example, contains the data: “sensor ID: multi-feeding detection sensor SN12, detection start time: 30.150, detection end time: 30.570” if an A3-size sheet (whose length is 420 mm) is conveyed at a speed of 1000 mm/s. The detection start time is determined as described above because the leading edge of the fed sheet passes the multi-feeding detection sensor SN12 when 150 msec has elapsed since the sheet conveyance time. The detection end time is determined, based on a time of 420 msec in which the sheet having a length of 420 mm passes through the multi-feeding detection sensor SN12 (the time of period in which the detection is performed may be determined based on the sheet length, or may be determined based on another parameter). Upon receiving the multi-feeding-detection start instruction, the multi-feeding detection portion SS4 performs a process for detecting the multi-feeding, and starts the detection of the multi-feeding at the detection start time of 30.150.

After that, in the second embodiment, the CPU 151 determines whether the conveyance sensor SN4 has detected the leading edge of the sheet S1 (S61). If the conveyance sensor SN4 has not detected the leading edge of the sheet S1 (S61: No), then the CPU 151 repeats the process until the conveyance sensor SN4 detects the leading edge of the sheet S1. If the conveyance sensor SN4 has detected the leading edge of the sheet S1 (S61: Yes), then the CPU 151 proceeds to Step S62.

If the CPU 151 proceeds to Step S62, then the CPU 151 determines whether the result of the multi-feeding detection, sent from the multi-feeding detection portion SS4, indicates that the multi-feeding has occurred (S62). The CPU 151 proceeds to Step S63 if the CPU 151 determines that the multi-feeding has occurred (S62: Yes), or proceeds to Step S27 if the CPU 151 determines that the multi-feeding has not occurred (S62: No). In a case where the multi-feeding has occurred and the CPU 151 proceeds to Step S63, the leading edge of the multi-fed sheet S1 has been detected in the above-described Step S61, by the conveyance sensor SN4. In this case, the CPU 151 then sends an instruction for switching the switching portion FL1 (Flapper). That is, the CPU 151 drives the switching portion FL1 and switches the switching portion FL1 from the first position that is an initial position, to the second position if the conveyance sensor SN4 has detected the sheet S1 and the multi-feeding has occurred.

Then the CPU 151 notifies the sheet-feeding-apparatus management portion SS1 of the occurrence of multi-feeding (S19). In addition, the occurrence of multi-feeding is notified to the print portion 200 via the sheet-feeding-apparatus management portion SS1. The notification may be performed when the sheet S1 and the sheet S2 are discharged to the sheet discharging port 115. However, if the notification is performed earlier, the following sheet S3 can be stopped earlier, and the operation of the print portion 200 can be stopped or changed earlier.

Then the CPU 151 determines whether the conveyance sensor SN4 has detected the trailing edge of the sheet S2 of the multi-fed sheets (S71). If the conveyance sensor SN4 has not detected the trailing edge of the sheet S2 (S71: No), then the CPU 151 repeats the process until the conveyance sensor SN4 detects the trailing edge of the sheet S2. If the conveyance sensor SN4 has detected the trailing edge of the sheet S2 (S71: Yes), then the CPU 151 proceeds to Step S72.

If the CPU 151 proceeds to Step S72, then the CPU 151 sends an instruction for returning the switching portion FL1 (Flapper) to the first position. With this operation, the switching portion FL1 can be returned from the second position to the first position when the trailing edge of the sheet S2 passes through the switching portion FL1. This is because the trailing edge of the sheet S2 which has passed through the switching portion FL1 in a state where the sheet S2 is shifted from the sheet S1 due to the multi-feeding has been detected by the conveyance sensor SN4. As a result, the sheet S2 can be prevented from being caught by the switching portion FL1, so that the occurrence of jam can be prevented.

Then the CPU 151 determines whether the sheet S1 and the sheet S2 are discharged to the sheet discharging port 115 (S20). The completion of discharging sheets may be determined based on time. In another case, a sensor for monitoring the conveyance of sheets may be disposed in the vicinity of the sheet discharging port 115, and the sensor may monitor the passage of the trailing edge of the sheet S2. The sheet-discharging completion time can be calculated by adding the time at which the leading edge of the sheet S1 reaches the sheet discharging port 115 (when 905 msec has elapsed since the start of conveyance of the sheet S1 from the second sheet-feeding cassette) (see FIG. 7), with a time that corresponds to a length of a multi-fed sheet (including the amount of shift in the multi-feeding). If the sheet discharging is not completed (S20: No), then the CPU 151 repeats the process until the sheet discharging is completed. If the sheet discharging is completed (S20: Yes), then the CPU 151 proceeds to Step S21.

If the CPU 151 proceeds to Step S21, then the CPU 151 notifies the conveyance control portion SS2 of the completion of discharging the sheets to the error bin (i.e., the sheet discharging port 115). With this operation, the CPU 151 stops the sheet discharging roller (S22), and ends the conveyance control of the sheet feeding apparatus 110.

On the other hand, as described above, if the instruction for feeding and conveying a sheet is, in Step S12, an instruction for receiving the sheet S3 conveyed from the above-described upstream apparatus, then the CPU151 proceeds to Step S23. If the CPU 151 proceeds to Step S23, then the CPU 151 determines whether a sheet reception time is reached. If the sheet reception time is not reached (S23: No), then the CPU 151 repeats the process until the sheet reception time is reached. If the sheet reception time is reached (S23: Yes), then the CPU 151 proceeds to Step S24. If the CPU 151 proceeds to Step S24, then the CPU 151 receives the sheet S3 from the upstream apparatus.

Then the CPU 151 determines whether a passage time at which the sheet S3 passes through the error-bin branch point (P5) is reached (S25). If the passage time is not reached (S25: No), then the CPU 151 repeats the process until the passage time is reached. If the passage time is reached (S25: Yes), then the CPU 501 proceeds to Step S26.

In Step S26, the CPU 151 determines whether the direction of the conveyance path extends toward a downstream apparatus disposed downstream in the conveyance direction V (i.e., the print portion 200, the sheet feeding apparatus 110 if the sheet is fed from the sheet feeding apparatus 120, or the sheet feeding apparatus 120 if the sheet is fed from the sheet feeding apparatus 130). That is, the CPU 151 determines whether the switching portion FL1 is positioned in the initial position. If the direction of the conveyance path extends toward the downstream apparatus (S26: Yes), then the CPU 151 proceeds to Step S27.

If the CPU 151 proceeds to Step S27 in a case where the multi-feeding has not occurred in the above-described Step S62 (S62: No), or where the direction of the conveyance path extends toward the downstream apparatus (S26: Yes), then the CPU 151 determines whether the sheet S1 or S3 has been discharged to the downstream apparatus. The completion of discharging the sheet to the downstream apparatus may be determined based on time. In another case, a sensor for monitoring the conveyance of sheets may be disposed in the vicinity of the sheet discharging port EX1, and the sensor may monitor the passage of the trailing edge of the sheet S1 or S3. The sheet-discharging completion time can be calculated by adding the time at which the leading edge of the sheet reaches the sheet discharging port EX1 (when 705 msec has elapsed since the start of conveyance of the sheet S1 from the second sheet-feeding cassette) (see FIG. 7), with a time that corresponds to a length of the sheet. If the sheet discharging is not completed (S27: No), then the CPU 151 repeats the process until the sheet discharging is completed. If the sheet discharging is completed (S27: Yes), then the CPU 151 proceeds to Step S28. If the CPU 151 proceeds to Step S28, then the CPU 151 notifies the conveyance control portion SS2 of the completion of normally delivering the sheet S1 or S3 to the downstream apparatus, and proceeds to Step S22. With this operation, the CPU 151 stops the sheet discharging roller (S22), and ends the conveyance control of the sheet feeding apparatus 110.

On the other hand, if the direction of the conveyance path does not extend toward the downstream apparatus in the above-described Step S26 (S26: No), that is, if the switching portion FL1 has been switched and the direction of the conveyance path extends toward the sheet discharging port 115, then the CPU 151 proceeds to the above-described Step S71. In this case, the preceding sheet S1 and the sheet S2 have been multi-fed, and the sheet S3 conveyed from the upstream apparatus has reached the switching portion FL1 before the switching portion FL1 is returned to the first position, because the amount of shift is large. Thus, in this case, the switching portion FL1 cannot be returned to the first position.

If the CPU 151 proceeds to Step S71 in this manner, then the CPU 151 determines whether the conveyance sensor SN4 has detected the trailing edge of the sheet S3 that follows the multi-fed sheet S1 and the multi-fed sheet S2 (S71). If the conveyance sensor SN4 has not detected the trailing edge of the sheet S3 (S71: No), then the CPU 151 repeats the process until the conveyance sensor SN4 detects the trailing edge of the sheet S3. If the conveyance sensor SN4 has detected the trailing edge of the sheet S3 (S71: Yes), then the CPU 151 proceeds to Step S72.

If the CPU 151 proceeds to Step S72, then the CPU 151 sends an instruction for returning the switching portion FL1 to the first position. With this operation, the switching portion FL1 can be returned from the second position to the first position when the trailing edge of the sheet S3 passes through the switching portion FL1. This is because the trailing edge of the sheet S3 following the multi-fed sheet S1 and the multi-fed sheet S2 and received from the upstream apparatus has been detected by the conveyance sensor SN4, in addition to the detection of the multi-fed sheet S1 and the multi-fed sheet S2. As a result, the sheet S3 can be prevented from being caught by the switching portion FL1, so that the occurrence of jam can be prevented.

Then the CPU 151 determines whether the sheets S1 to S3 are discharged to the sheet discharging port 115 (S20). If the sheet discharging is not completed (S20: No), then the CPU 151 repeats the process until the sheet discharging is completed. If the sheet discharging is completed (S20: Yes), then the CPU 151 notifies the conveyance control portion SS2 of the completion of discharging the sheets to the error bin (i.e., the sheet discharging port 115). With this operation, the CPU 151 stops the sheet discharging roller (S22), and ends the conveyance control of the sheet feeding apparatus 110.

Note that in the above-described conveyance control of the sheet feeding apparatus 110, the plurality of conveyance rollers that serve as the conveyance portion 110A is collectively driven or stopped. However, only necessary conveyance rollers may be driven or stopped in a sequential manner by calculating the time at which the sheet reaches a corresponding component.

In addition, although the leading edge of a multi-fed sheet is detected by the conveyance sensor SN4 in the present embodiment, the passage of the leading edge of the multi-fed sheet may be determined, based on time. This is because the passage time of the leading edge of a sheet in a case where the sheet is multi-fed is the same as the passage time of the leading edge of the sheet in a case where the sheet is not multi-fed.

### Summary of Second Embodiment

As described above, if the sheet S1 and the sheet S2 are multi-fed, there is a case where the sheet S1 and the sheet S2 overlap with each other, shifted from each other. In this case, the trailing edge of the sheet S2 passes through (reaches) the switching portion FL1, delayed from the trailing edge of the sheet S1 by the amount of shift. However, in the sheet feeding apparatus 110, in a case where the control portion 150 (i.e., the CPU 151) detects the multi-feeding by using the multi-feeding detection sensor, the conveyance sensor SN4 detects that the trailing edge of the sheet S2 has passed through the switching portion FL1. In addition, if the conveyance sensor SN4 detects that the trailing edge of the sheet S2 has passed through the switching portion FL1, the control portion 150 switches the switching portion FL1 from the second position to the first position. With this operation, the multi-fed sheet S1 and the multi-fed sheet S2 can be appropriately guided to the error sheet-discharging path Ps14, and the switching portion FL1 can be switched after the trailing edge of the sheet S2 passes through the switching portion FL1. As a result, the occurrence of jam can be prevented.

In addition, in a case where the sheet S3 is conveyed following the sheet S2, if the timing at which the leading edge of the sheet S3 passes through the switching portion FL1 is earlier than the timing at which the trailing edge of the sheet S2 passes through the switching portion FL1, the control portion 150 switches the switching portion FL1 to the first position after the conveyance sensor SN4 detects that the trailing edge of the sheet S3 has passed through the switching portion FL1. With this operation, the switching portion FL1 is switched after the trailing edge of the sheet S3 passes through the switching portion FL1. As a result, the occurrence of jam caused by the sheet S3 being caught by the switching portion FL1 can be prevented.

Since the other configuration, operations, and effects of the second embodiment are the same as those of the above-described first embodiment, the description thereof will be omitted.

The present invention can prevent the occurrence of jam while guiding the multi-fed first and second sheets to the third conveyance path.

### Other Embodiments

In the above-described first and second embodiments, in a case where the multi-feeding is detected in the sheet feeding apparatus 110, multi-fed sheets are discharged to the sheet discharging tray 119. However, the present disclosure is not limited to this configuration. That is, the present disclosure is applicable to any configuration as long as multi-fed sheets are conveyed, in the configuration, to a portion other than the portion to which normal sheets are conveyed. For example, the present invention may be applied to a portion of the fixing portion 300 in which error sheets are discharged toward the sheet discharging port 301. Similarly, the present invention may be applied to a portion of the reversing portion 500 in which error sheets are discharged toward the sheet discharging port 501. In a case where the present invention is applied to the reversing portion 500, the destination to which normal sheets (which are not unacceptable) are conveyed is a discharging tray for the normal sheets. That is, the destination to which normal sheets are conveyed may not be the image forming portion.

In addition, in the first and second embodiments, the description has been made for the case where time is used for managing the position of a sheet. However, the present disclosure is not limited to this. For example, the position of a sheet may be managed by using the time that is counted from a reference time (e.g., the time counted from when power is turned on, or the time counted from a time specified for starting to feed a sheet). In another case, the position of a sheet may be managed by using the coordinates at which the sheet is located in the apparatus, and the time in which the sheet has moved may be calculated by using the coordinates and the conveyance speed.

In addition, in the first embodiment, the description has been made for the case where the time (i.e., the conveyance-path return start time) at which the trailing edge of the sheet S2 passes through the switching portion FL1 is calculated in accordance with the amount of shift (i.e., the multi-feeding shift time t) (see FIG. 13) between the multi-fed sheet S1 and the multi-fed sheet S2. However, the time at which the trailing edge of the sheet S2 passes through the switching portion FL1 may be calculated by using any method. For example, the leading edge of the sheet S2 (i.e., the multi-feeding occurrence time Td) may be detected, and then the multi-feeding occurrence time Td may be added with the time obtained by dividing the length of the sheet S2 in the conveyance direction V by the conveyance speed.

In addition, since the image forming system 1 described in the first and second embodiments is one example, the system to which the present disclosure is applied may be any system as long as the system has a configuration for conveying sheets and causing the switching portion to switch the conveyance path. In particular, the system to which the present disclosure is applied is not limited to a system in which the image forming portion has an ink-jet system. For example, the system to which the present disclosure is applied may be a system in which the image forming portion has an electrophotographic system.

The present disclosure may be embodied by providing a program, which achieves one or more functions of the above-described embodiments, to a system or an apparatus via a network or a storage medium, and by causing one or more processors of the system or the apparatus to read and execute the program. In addition, the present disclosure may be embodied by a circuit (e.g., an ASIC) that achieves one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-035939, filed Mar. 8, 2024, which is hereby incorporated by reference herein in its entirety.

What is claimed is:

1. A sheet conveyance apparatus comprising:
a conveyance portion configured to convey a sheet;
a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path;
a multi-feeding detection portion disposed upstream of the switching portion in a sheet conveyance direction and configured to detect multi-feeding in which a first sheet and a second sheet that follows the first sheet overlap with each other; and
a control portion configured to control the switching portion for guiding the first sheet and the second sheet to the third conveyance path by switching the switching portion to the second position in a case where multi-feeding is detected by the multi-feeding detection portion,
wherein in the case where multi-feeding is detected by the multi-feeding detection portion, the control portion is configured to calculate a first time at which a trailing edge of the second sheet in the sheet conveyance direction has been passed through the switching portion, and switch the switching portion from the second position to the first position at the first time.

2. The sheet conveyance apparatus according to claim 1, wherein in the case where multi-feeding is detected by the multi-feeding detection portion, the control portion is configured to switch the switching portion from the second position to the first position based on an amount of shift between a leading edge of the first sheet and a leading edge of the second sheet in the sheet conveyance direction.

3. The sheet conveyance apparatus according to claim 1, wherein the control portion is configured to calculate the first time by adding a length of time from a time when the multi-feeding detection portion detects a leading edge of the first sheet to a time when the multi-feeding detection portion detects multi-feeding, to a second time at which the trailing edge of the first sheet in the sheet conveyance direction passes through the switching portion.

4. The sheet conveyance apparatus according to claim 1, wherein in a case where a third sheet that follows the second sheet is conveyed, if a third time at which a leading edge of the third sheet in the sheet conveyance direction passes through the switching portion is earlier than the first time, the control portion is configured to cancel switching of the switching portion to be perform at the first time.

5. The sheet conveyance apparatus according to claim 1, wherein the second conveyance path is a conveyance path for conveying the sheet to an image forming portion configured to form an image on the sheet.

6. The sheet conveyance apparatus according to claim 5, wherein the image forming portion is configured to form an image by using an ink-jet system.

7. The sheet conveyance apparatus according to claim 1, further comprising:
a discharging support portion configured to support the sheet discharged,
wherein the third conveyance path is a conveyance path for conveying the sheet to the discharging support portion.

8. The sheet conveyance apparatus according to claim 1, further comprising:
a support portion configured to support a plurality of sheets; and
a feeding portion configured to feed the sheets supported by the support portion to the first conveyance path.

9. A sheet conveyance apparatus comprising:
a conveyance portion configured to convey a sheet;
a switching portion configured to be switched between a first position and a second position, the first position being a position at which the switching portion guides the sheet conveyed in a first conveyance path by the conveyance portion, to a second conveyance path, the second position being a position at which the switching portion guides the sheet conveyed in the first conveyance path by the conveyance portion, to a third conveyance path;
a multi-feeding detection portion disposed upstream of the switching portion in a sheet conveyance direction and configured to detect multi-feeding in which a first sheet and a second sheet that follows the first sheet overlap with each other;
a trailing-edge detection portion disposed upstream of the switching portion in the sheet conveyance direction and configured to detect a trailing edge of the second sheet in the sheet conveyance direction; and
a control portion configured to control the switching portion for guiding the first sheet and the second sheet to the third conveyance path by switching the switching portion to the second position in a case where multi-feeding is detected by the multi-feeding detection portion,
wherein in the case where multi-feeding is detected by the multi-feeding detection portion, the control portion is configured to switch the switching portion from the second position to the first position based on detecting the trailing edge of the second sheet by the trailing-edge detection portion.

10. The sheet conveyance apparatus according to claim 9, wherein the trailing-edge detection portion is disposed with a distance from the switching portion in the sheet conveyance direction.

11. The sheet conveyance apparatus according to claim 9, wherein the control portion is configured to switch the switching portion to the second position in a case where the trailing-edge detection portion detects a leading edge of the first sheet in the sheet conveyance direction and the multi-feeding detection portion detects multi-feeding.

12. The sheet conveyance apparatus according to claim 9, wherein the second conveyance path is a conveyance path for conveying the sheet to an image forming portion configured to form an image in the sheet.

13. The sheet conveyance apparatus according to claim 12, wherein the image forming portion is configured to form an image by using an ink-jet system.

14. The sheet conveyance apparatus according to claim 9, further comprising:
a discharging support portion configured to support the sheet discharged,
wherein the third conveyance path is a conveyance path for conveying the sheet to the discharging support portion.

15. The sheet conveyance apparatus according to claim 9, further comprising:
a support portion configured to support a plurality of sheets; and
a feeding portion configured to feed the sheets supported by the support portion to the first conveyance path.

16. An image forming system comprising:
the sheet conveyance apparatus according to claim 1; and
an image forming apparatus configured to form an image on the sheet conveyed from the sheet conveyance apparatus.
